(19) United States
(12) Patent Application Publication
(10) Pub. No.: US 2026/0252357 A1
(43) Pub. Date: Aug. 27, 2026

(54) SYSTEM AND METHOD FOR PERFORMANCE ENHANCEMENT ON A DATA FLOW ARCHITECTURE

(71) Applicant: SambaNova Systems, Inc., Palo Alto, CA (US)

(72) Inventors: Abhishek SRIVASTAVA, Sunnyvale, CA (US); Badreddine Noune, Palo Alto, CA (US); Andrew DENG, San Jose, CA (US); Sankar RACHURU, Palo Alto, CA (US); Wei Pei, Palo Alto, CA (US); Isfan Gunawan, Mountain View, CA (US); David Alan KOEPLINGER, Egg Harbor, NJ (US)

(73) Assignee: SambaNova Systems, Inc., Palo Alto, CA (US)

(21) Appl. No.: 19/547,082

(22) Filed: Feb. 23, 2026

Related U.S. Application Data
(60) Provisional application No. 63/761,864, filed on Feb. 21, 2025.

(51) Int. Cl. G06F 9/38; G06F 7/483

(52) U.S. Cl. CPC G06F 9/3867; G06F 7/483

(57) ABSTRACT

In one implementation, a computer implemented method for performing different tasks uses two different procedures for two of the tasks. One of the procedures uses one section of the computer to process a first group of data according to one procedure, and a different procedure uses a second section of the computer to process other data according to a second procedure.

### PRIORITY CLAIM TO PRIOR PROVISIONAL FILING

This application claims priority to prior filed Provisional Application no. 63/761,864 entitled “A software method for performant emulated fp8 inference on Dataflow Architectures” filed on Feb. 21, 2025, having a docket number of SBNV1236USP01, and having common inventors Srivastava et al. which is hereby incorporated herein by reference.

### CROSS-REFERENCE TO RELATED DOCUMENTS AND APPLICATIONS

This application is related to U.S. patent application Ser. No. 19/396,316 entitled “SYSTEM AND METHOD FOR BATCHED SPECULATIVE DECODING ON A DATA FLOW ARCHITECTURE”, filed on Nov. 20, 2025, having a docket number of SBNV1204USN01 which is hereby incorporated herein by reference.

This application is also related to the following published documents:
Prabhakar et al., “Plasticine: A Reconfigurable Architecture for Parallel Patterns,” ISCA '17, June 24-28, 2017, Toronto, ON, Canada;
Koeplinger et al., “Spatial: A Language and Compiler for Application Accelerators,” Proceedings of the 39th ACM SIGPLAN Conference on Programming Language Design and Implementation (PLDI), Proceedings of the 43rd International Symposium on Computer Architecture, 2018;
U.S. patent application Ser. No. 16/922,975, filed Jul. 7, 2020, entitled “RUNTIME VIRTUALIZATION OF RECONFIGURABLE DATA FLOW RESOURCES;”
U.S. patent application Ser. No. 18/218,562, published as US 2024/0020261, entitled “Peer-To-Peer Route Through In A Reconfigurable Computing System,” filed on Jul. 5, 2023;
U.S. patent application Ser. No. 18/383,718, published as US 2024/0073129, entitled “Peer-To-Peer communication between Reconfigurable Dataflow Units,” filed Oct. 25, 2023;
U.S. patent application Ser. No. 16/239,252, now U.S. Pat. No. 10,698,853, entitled “Virtualization of a Reconfigurable Data Processor,” filed Jan. 3, 2019;
U.S. Pat. No. 11,386,038 B2, issued on Jul. 12, 2022, entitled “Control Flow Barrier And Reconfigurable Data Processor”, filed on May 9, 2019;
U.S. Patent Publication No. 2023/0244748, published on Aug. 3, 2023, entitled “Matrix Multiplication On Coarse-Grained Computing Grids”, filed on May 25, 2022;
U.S. patent application Ser. No. 18/107,613, published as US 2023/0251839, entitled “Head Of Line Blocking Mitigation In A Reconfigurable Data Processor,” filed on Feb. 9, 2023, and
U.S. patent application Ser. No. 18/107,690, published as US 2023/0251993, entitled “Two-Level Arbitration in a Reconfigurable Processor,” filed on Feb. 9, 2023; and
U.S. Patent Publication No. 2024/0086235, published on Mar. 14, 2024, entitled “Estimating Resource Costs For Computing Tasks For A Reconfigurable Dataflow Computer System”, filed on Sep. 13, 2023.

### BACKGROUND

### Technical Field

The technology disclosed relates to improved management of resources for a reconfigurable data processor and relates to processing instructions and moving data in at least a coarse grain reconfigurable processor.

### Context

With the rapid expansion of applications, such as natural-language processing and Large Language models, the performance and efficiency challenges of traditional, instruction set architectures have become apparent. Dataflow architectures have been used for processing the different types of models. Different workloads of the various tasks of the models can had various effect on the processing time of the system. The different effects often resulted in slowed system performance. As a result, developers can no longer use the models without some system degradation. Thus, it is useful to have a method and architecture that can improve the system performance.

### BRIEF DESCRIPTION OF THE DRAWINGS

FIG. 1 illustrates a simplified block diagram of an example of portions of an implementation of a computer system including a coarse grained reconfigurable processor;

FIG. 2 illustrates an example of portions of an implementation of a CGR array, including one or more Arrays of CGR units (ACGRUs) connected to one or more array level networks (ALNs);

FIG. 3 illustrates an example of portions of an implementation of a CGR array, including an Array of CGR units (ACGRUs) connected in an ALN;

FIG. 4 is a block diagram illustrating an example of an implementation of a pattern compute unit (PCU) that may be an example of one or more of the CGRUs of FIG. 3;

FIG. 5 illustrates a portion of an example of an implementation of some of functional units of the PCU of FIG. 4;

FIG. 6A illustrates a simplified block diagram of an example of an implementation of a pattern memory unit (PMU) that may be substantially the same as one or more of the CGRUs of FIG. 3;

FIG. 6B illustrates a simplified block diagram of an example of an implementation of a Fused Compute Memory Unit (FCMU);

FIG. 7 is a simplified block diagram illustration of an example of an implementation of a host computer system or host including a host computer processor and a host storage unit;

FIG. 8 illustrates of an example of at least a portion of an implementation of a complier system or compiler stack that may be used to compile dataflow graphs for a reconfigurable dataflow architecture;

FIG. 9 illustrates an example of a model of an implementation of a neural network (NN);

FIG. 10 illustrates in a general manner a quantized tensor matrix;

FIG. 11 is a flowchart illustrating some general steps in a method of creating a dataflow graph that includes separate operations for different tasks of the dataflow graph;

FIG. 12 is a block diagram illustrating an array of CGRU(s) configured into pipelines; and

FIG. 13 illustrates in a general manner an example of a portion of an implementation of a method of operating at least a portion of the ACGRU of FIG. 1.

### DETAILED DESCRIPTION

As will be seen hereinafter, an improved method of configuring the architecture of a reconfigurable dataflow architecture and an improved method of performing some of the tasks using the reconfigurable dataflow architecture improve the processing speed of the reconfigurable dataflow architecture.

As used herein, the phrase “one of” should be interpreted to mean exactly any one of the listed items. For example, the phrase “one of A, B, and C” should be interpreted to mean any of: only A, only B, or only C

As used herein, the phrases “at least one of” and “one or more of” should be interpreted to mean one or more items. For example, the phrase “at least one of A, B, or C” or the phrase “one or more of A, B, or C” should be interpreted to mean any number of the items of A, B, and/or C. The phrase “at least one of A, B, and C” means at least one of A and at least one of B and at least one of C.

Unless otherwise specified, the use of ordinal adjectives “first”, “second”, “third”, etc., to describe an object, merely refers to different instances or classes of the object and does not imply any ranking or sequence. The terms first, second, third and the like in the Claims or/and in the Detailed Description, as used in a portion of a name of an element, are used for distinguishing between similar elements and not necessarily for describing a sequence, either temporally, spatially, in ranking or in any other manner. It is to be understood that the terms so used are interchangeable under appropriate circumstances and that the implementations or embodiments described herein are capable of operation in other sequences than described or illustrated herein.

The terms “comprising” and “consisting of” have different meanings in this application. An apparatus, method, or product “comprising” (or “including”) certain features means that it includes those features but does not exclude the presence of other features. On the other hand, if the apparatus, method, or product “consists of” certain features, the presence of any additional features is excluded.

The term “coupled” is used in an operational sense and is not limited to a direct or an indirect coupling. Coupled in an electronic system may refer to a configuration that allows a flow of information, signals, data, or physical quantities such as electrons between two elements coupled to or coupled with each other. In some cases, the flow may be unidirectional, in other cases the flow may be bidirectional or multidirectional. Coupling may be indirect through galvanic, capacitive, inductive, electromagnetic, optical, or through any other electrical element or process allowed by physics.

The term “connected” is used to indicate a direct connection, such as electrical, optical, electromagnetic, or mechanical, between the things that are connected, without any intervening things or devices.

The term “configured” to perform a task or tasks is a broad recitation of structure generally meaning having circuitry that performs the task or tasks during operation. As such, the described item or circuit elements can be configured to perform the task even when the unit/circuit/component is not currently on or active. In general, the circuitry that forms the structure corresponding to “configured to” may include hardware circuits, and may further be controlled by switches, logical or analog electronics, fuses, bond wires, metal masks, firmware, and/or software. Similarly, various items may be described as performing a task or tasks, for convenience in the description. Such descriptions should be interpreted as including the phrase configured to. Reciting an item that is configured to perform one or more tasks is expressly intended not to invoke 35 U.S.C. 112, paragraph (f) interpretation for that unit/circuit/component. More generally, the recitation of any element is expressly intended not to invoke 35 U.S.C. $ 112, paragraph (f) interpretation for that element unless the language “means for” or “step for” is specifically recited.

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an implementation in which A is determined based solely on B. The phrase “based on” is thus synonymous with the phrase “based at least in part on.”

The words “during”, “while”, and “when” as used herein relating to an operation are not exact terms that mean an action takes place instantly upon an initiating action but that there may be some small but reasonable delay(s), such as various propagation delays, between the reaction that is initiated by the initial action. Additionally, the term “while” means that a certain action occurs at least within some portion of a duration of the initiating action. When used in reference to a state of a signal or a logic state, the term “asserted” means an active state of the signal or logic state and the term “negated” means an inactive state of the signal or logic state. The actual voltage value or logic state (such as a “1” or a “0 ” of the logic state or the “high” or “low” voltage value of a signal) depends on whether positive or negative logic is used. Thus, asserted can be either a high voltage or a high logic or a low voltage or low logic depending on whether positive or negative logic is used and negated may be either a low voltage or low state or a high voltage or high logic depending on whether positive or negative logic is used. Herein, a positive logic convention is used wherein “asserted” is a high logic state or high voltage value, but those skilled in the art understand that a negative logic convention could also be used.

The terms “close”, “near”, and “about” refer to being within minus or plus 10% of an indicated value, unless explicitly specified otherwise. The use of the word “approximately” or “substantially” means that a value of an element has a parameter that is expected to be close to a stated value or position. However, as is well known in the art there are always minor variances that prevent the values or positions from being exactly as stated. It is well established in the art that variances of up to at least ten per cent (10%) (and up to twenty per cent (20%) for some elements including semiconductor doping concentrations and shapes of sidewalls/distances of doped regions) are reasonable variances from the ideal goal of exactly as described.

For simplicity and clarity of the illustration(s), elements in the figures are not necessarily to scale, some of the elements may be exaggerated for illustrative purposes, and the same reference numbers in different figures denote the same elements, unless stated otherwise. Cross hatched regions or cross-hatching in the drawings is used merely to assist in distinguishing boundaries of different regions and does not imply any type of materials. Additionally, descriptions and details of well-known steps and elements may be omitted for simplicity of the description. Neither the figures nor the Detailed Description are intended to limit the scope as claimed. Instead, they merely represent examples of different implementations.

Reference to “one embodiment” or “an embodiment” or an “implementation” means that a particular feature, structure, or characteristic described in connection with the embodiment or implementation is included in at least one implementation. Thus, appearances of the phrases “in one implementation” or “in an implementation” in various places throughout this specification are not necessarily all referring to the same implementation, but in some cases it may. Furthermore, the particular features, structures or characteristics may be combined in any suitable manner and in a wide variety of different implementations, as would be apparent to one of ordinary skill in the art, in one or more implementations.

The embodiments or implementations illustrated and described hereinafter may have implementations and/or may be practiced in the absence of any element which is not specifically disclosed herein.

The terms “IC, integrated circuit, monolithically integrated circuit” include at least a single semiconductor die which may be delivered as a bare die or as a packaged circuit. For the purposes of this document, the term integrated circuit also includes packaged circuits that may include multiple semiconductor dies, stacked dies, or multiple-die substrates. Such constructions are now common in the industry, produced by the same supply chains, and for the average user often indistinguishable from monolithic circuits.

The following terms or acronyms used herein are defined at least in part as follows:
AGCU—address generator (AG) and coalescing unit (CU).
AI—artificial intelligence.
AIR—arithmetic or algebraic intermediate representation.
ALN—array-level network.
Buffer—an intermediate storage of data.
CGR—coarse-grained reconfigurable. A property of, for example, a system, a processor (CGRP), an architecture (see CGRA), an array, or a unit in an array (CGRU). This property distinguishes the system, etc., from field-programmable gate arrays (FPGAs), which can implement digital circuits at the gate level and are therefore fine-grained configurable.
CGRA—coarse-grained reconfigurable architecture. A data processor architecture that includes one or more arrays (CGR arrays) of CGR units (CGRUs).
CGR Array or ACGRU—an array of CGR units (ACGRUs), coupled with each other through one or more array-level networks (ALNs). ACGRU may be coupled with external elements via a top-level network (TLN). A CGR array can physically implement the nodes and edges of a Graph.
Compiler—a translator that processes statements written in a programming language to machine language instructions for a computer processor. A compiler may include multiple stages to operate in multiple steps. Each stage may create or update an intermediate representation (IR) of the translated statements. For the purposes of this disclosure, an assembler that generates configuration data for a CGR processor from low-level so-called assembly language code can also be referred to as a compiler.
Computation graph—some algorithms can be represented as computation graphs. As used herein, computation graphs are a type of directed graphs comprising nodes that represent mathematical operations/expressions and edges that indicate dependencies between the operations/expressions. For example, with machine learning (ML) algorithms input layer nodes assign variables, output layer nodes represent algorithm outcomes, and hidden layer nodes perform operations on the variables. Edges represent data (e.g., scalars, vectors, tensors) flowing between operations. In addition to dependencies, the computation graph reveals which operations and/or expressions can be executed concurrently.
Dataflow Graph or Graph—a computation graph that includes one or more loops that may be nested, and wherein nodes can send messages to nodes in earlier layers to control the dataflow between the layers. For example, a collection of nodes connected by edges. Nodes may represent various kinds of items or operations, dependent on the type of graph. Edges may represent relationships, directions, dependencies, etc. A Graph may include any or all elements of either or both of a Dataflow Graph or a Computational graph.
CGR unit or CGRU—a circuit that can be configured and reconfigured to locally either or both of store data (e.g., a pattern memory unit or a PMU), or to execute a programmable function (e.g., a pattern compute unit or a PCU). A CGR unit includes hardwired functionality that performs a limited number of functions used in computation graphs and dataflow graphs. Further examples of CGR units include a CU and an AG, which may be combined in an AGCU. Some implementations include CGR switches, whereas other implementations may include regular switches.
CU—coalescing unit.
Dataflow Graph—a computation graph that includes one or more loops that may be nested, and wherein nodes can send messages to nodes in earlier layers to control the dataflow between the layers.
Graph—a collection of nodes connected by edges. Nodes may represent various kinds of items or operations, dependent on the type of graph. Edges may represent relationships, directions, dependencies, etc. A Graph may include any or all elements of either or both of a Dataflow Graph or a Computational graph.
Datapath—a collection of functional units that perform data processing operations. The functional units may include memory, multiplexers, ALUs, SIMDs, multipliers, registers, buses, etc.
FCMU—fused compute and memory unit—a circuit that includes both a memory unit and a compute unit.
IC—integrated circuit—a monolithically integrated circuit, i.e., a single semiconductor die which may be delivered as a bare die or as a packaged circuit. For the purposes of this document, the term integrated circuit also includes packaged circuits that include multiple semiconductor dies, stacked dies, or multiple-die substrates. Such constructions are now common in the industry, produced by the same supply chains, and for the average user often indistinguishable from monolithic circuits.
A logical CGR array or logical CGR unit—a CGR array or a CGR unit that is physically realizable, but that may not have been assigned to a physical CGR array or to a physical CGR unit on an IC.
Metapipeline—a subgraph of a computation graph or graph that includes a producer operator providing its output as an input to a consumer operator. Metapipelines may be nested, that is, producer operators and consumer operators may include other metapipelines.
ML—machine learning.
Multi-Port Memory—A multi-port memory can include one or more arrays of memory cells that allow for concurrent access to the memory from more than one access port. This can be accomplished in several ways, depending on the implementation, including, but not limited to, a multi-port memory array, multiple banks of memory that allow access to the different banks of memory simultaneously, time multiplexing access to the memory cells from the access port, or a combination thereof.
PCU—pattern compute unit (or configurable compute unit)—a compute unit that can be configured to perform a sequence of operations.
PEF—processor-executable format—a file format suitable for configuring a configurable data processor.
Pipeline—a staggered flow of operations through a chain of pipeline stages. The operations may be executed in parallel and in a time-sliced fashion. Pipelining increases overall instruction throughput. CGR processors may include pipelines at different levels. For example, a compute unit may include a pipeline at the gate level to enable correct timing of gate-level operations in a synchronous logic implementation of the compute unit, and a metapipeline at the graph execution level (typically a sequence of logical operations that are to be repetitively executed) that enables correct timing and loop control of node-level operations of the configured graph. Gate-level pipelines are usually hard wired and unchangeable, whereas metapipelines are configured at the CGR processor, CGR array level, and/or GCR unit level.
Pipeline Stages—a pipeline is divided into stages that are coupled with one another to form a pipe topology.
PMU—pattern memory unit (or configurable memory unit)—a memory unit that can locally store data according to a programmed pattern.
PNR—place and route—the assignment of logical CGR units and associated processing/operations to physical CGR units in an array, and the configuration of communication paths between the physical CGR units.
RAIL—reconfigurable dataflow unit (RDU) abstract intermediate language.
SIMD—single-instruction multiple-data—an arithmetic logic unit (ALU) that simultaneously performs a single programmable operation on multiple data elements delivering multiple output results.
TLN—top-level network.

### Implementations

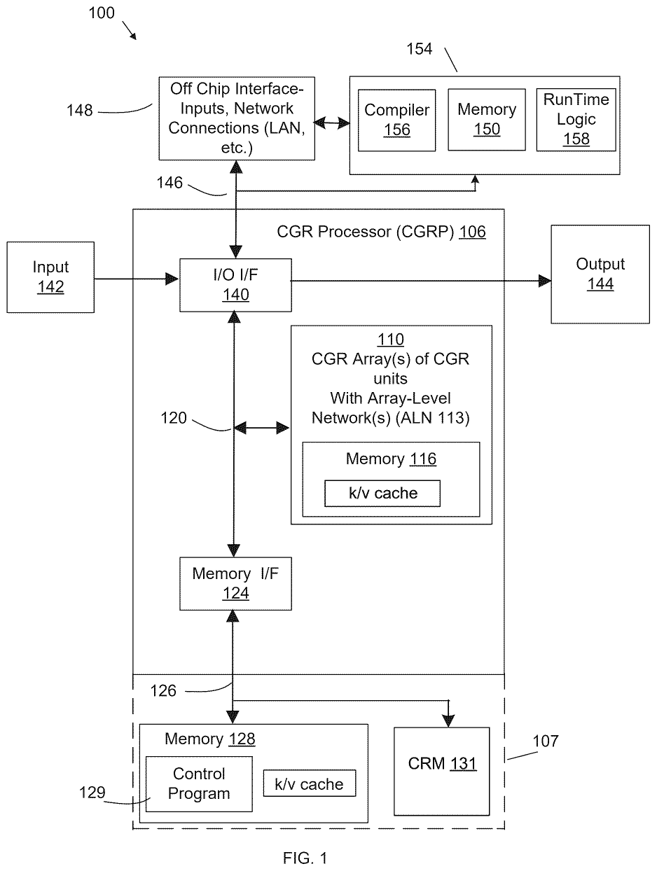

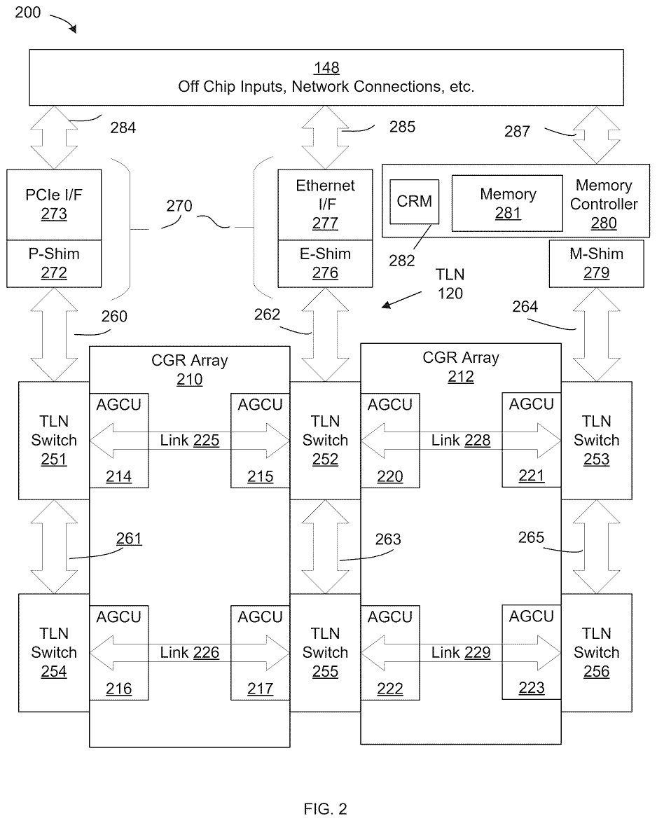

FIG. 1 illustrates a simplified block diagram of an example of portions of an implementation of a computer system 100. System 100 includes a coarse grained reconfigurable processor (CGRP) 106 that has a Coarse Grained Reconfigurable Architecture (CGRA), sometime referred to as a Reconfigurable Dataflow Architecture. In some implementations, CGRP 106 may be referred to as having a Reconfigurable Dataflow Architecture. System 100 also includes a host processor or host 154. System 100 as a whole may also be referred to having a Reconfigurable Dataflow Architecture because it includes CGRP 106. System 100 may have other configurations in other implementations as long as it includes a coarse grained reconfigurable architecture, such as for example CGRP 106. CGRP 106 has a coarse-grained reconfigurable architecture (CGRA) and includes one or more arrays of CGR units (ACGRUs) 110. For example (as illustrated in FIG. 2), CGRP 106 may include CGR Array1 210 and CGR Array2 212, although other implementations can have any number of arrays or tiles, including a single array or tile. CGRP 106 also includes an interface 148 for off chip connections (for example die-to-die) and for network connections (for example networks that are external to CGRP 106). An implementation of CGRP 106 may include a memory 128. Memory 128 may, in an implementation, be external to a chip or package that includes the arrays of CGR units (ACGRUs) 110 and a memory external to CGRP 106 but may be considered as a portion of CGRP 106, as illustrated by dashed lines 107. Memory 128 may be any of various types of memory, such as a high bandwidth memory (HBM) or DDR or other type of memory. CGRP 106 further may include an I/O interface (I/F) 140, and a memory interface (I/F) 124. Array of CGR units (ACGRUs) 110 is coupled with I/O interface (I/F) 140 and memory interface (I/F) 124 via a top-level network (TLN) 120 that may include one or more communication bus(s). Host 154 communicates with I/O interface 140 via system bus 146, and memory interface 124 may communicate with memory 128 via a memory bus 126. ACGRU 110 may include a memory 116 that may include one or more various memory types such as a high bandwidth memory (HBM) or DDR or other type of memory. In some implementations, a portion of memory 116 may be included within one or more memory units (MUs or PMUs) of ACGRU 110. ACGRU 110 may further include compute units (CU), pattern compute units (PCU), memory units (MU), pattern memory units (PMU), and/or fused compute-memory units (FCMU) that are interconnected with an array-level network (ALN) 113 to provide the circuitry for execution of a Graph, such as for example a computation graph or a dataflow graph, that may have been derived from a high-level program with user algorithms and functions. The high-level program may include a set of procedures, such as learning or inferencing in an AI or ML or LLM system. As will be seen further hereinafter, the reconfigurable dataflow architecture can support such high-level programs. For example, CGRP 106 may be scaled to use any number of processors in ACGRUs 110. The high-level program(s) may include applications, graphs, application graphs, user applications, computation graphs, control flow graphs, dataflow graphs, models, deep learning applications, deep learning neural networks, programs, program images, jobs, tasks and/or any other procedures and functions that may need serial and/or parallel processing. Various features and capabilities of the reconfigurable dataflow architecture (CGRA), whether in hardware or in software, may be configured to improve memory bandwidth or alternately to improve processing speed, such as configured for the functionality of the high-level program.

Host 154 can represent any of a variety of computer systems that can operate using a CPU and a corresponding operating system (OS) to enable the execution of software on host 154 using the CPU. As will be seen further hereinafter, the operating system on host 154 may enable execution of software to control CGRP 106, such as by providing a user space for general processing task execution and a kernel space for hardware I/O driver execution.

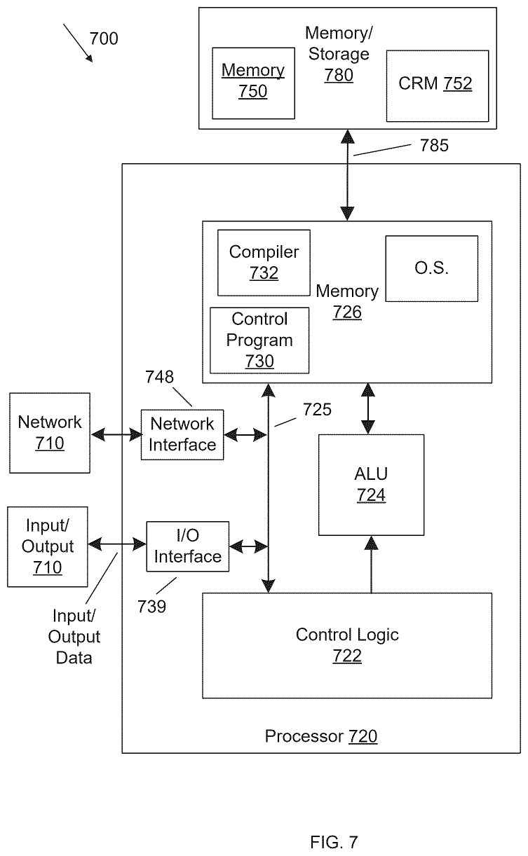

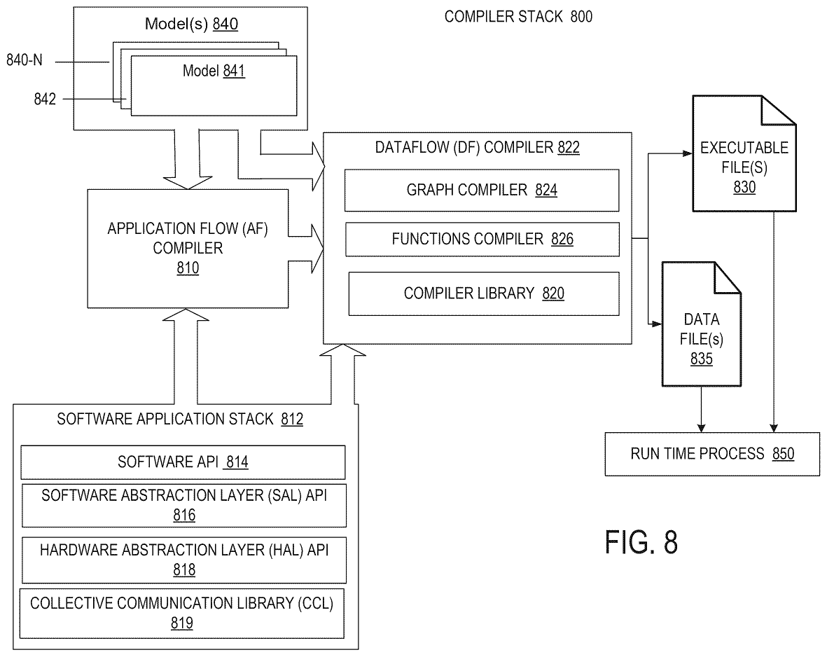

CGR processor (CGRP) 106 may accomplish computational tasks by executing a configuration file (for example, a PEF file). For the purposes of this description, a configuration file may correspond to a dataflow graph (or portions thereof), or a translation of a dataflow graph, and may further include initialization data. The configuration file may be stored in a configuration store/logic circuit (Cfg). A compiler, such as for example compiler 156 (or 732 FIG. 7, or 822 FIG. 8), may compile the high-level program to provide the configuration file. In some implementations, a CGR array or an ACGRU may be configured by programming one or more configuration stores in the configuration store/logic circuit (Cfg) of the CGRUs within the array, such as within ACGRU 110, with all or parts of the configuration file. A single configuration store/logic circuit (Cfg) may be at the level of the CGR processor (CGRP) or the CGR array, or one or more CGRUs of the CGR array may include an individual configuration store/logic circuit (Cfg). The configuration file may include configuration data for the CGR array and CGR units in the CGR array, and may link the computation graph to the CGR array. Execution of the configuration file by CGRP 106 causes ACGRU 110 to implement the user algorithms and functions in the dataflow graph.

CGRP 106 can be implemented on a single integrated circuit die or on a multichip module (MCM). The die for CGRP 106 can be packaged in a single chip module or a multichip module (MCM). An implementation may include that at least a portion of memory 128 may be included within the IC. A MCM is an electronic package that may comprise multiple IC die and other devices, assembled into a single module as if it were a single device. The various die of an MCM may be mounted on a substrate, and the bare die of the substrate are electrically coupled to the surface or to each other using, for example, wire bonding, tape bonding, or flip-chip bonding.

FIG. 2 illustrates an example of portions of an implementation of a CGR array 200, including one or more Arrays of CGR units (ACGRUs) connected to one or more ALN(s), such as for example ALN 113 (FIG. 1). CGR array 200 may be a portion CGRP 106, such as for example a portion of ACGRU 110, (FIG. 1) or in some implementations may be all of CGRP 106. For simplicity of the drawings, CGR array 200 is illustrated with two arrays of CGRU(s), illustrated as arrays 210 and 212. However, CGR array 200 may include fewer or more than two arrays of CGR units. Arrays 210 and 212 each include one or more types of CGR units (CGRUs), such as for example FCMUs, PMUs, PCUs, memory units (MU), and/or compute units (CU). In some implementations, some of the CGRUs may be PCUs or PMUs. In other implementations, some of the CGRUs may be an FCMU or memory units and compute units, arranged in a checkerboard pattern. In yet other implementations, the CGRUs may be arranged in different patterns. For examples of the functions of these types of CGRUs, see Prabhakar et al., “Plasticine: A Reconfigurable Architecture for Parallel Patterns”, ISCA 2017, Jun. 24-28, 2017, Toronto, ON, Canada.

Arrays 210 and 212 may have implementations that may be included as one or more of the ACGRUs describe in the explanation of ACGRU 110 (FIG. 1). Each of Arrays 210 and 212 may have one or more AGCUs (Address Generation and Coalescing Units) 214-217 and 220-223. The AGCUs are nodes on both top level network (TLN) 120 and on array-level networks (ALNs) within their respective Arrays 210 and 212, and include resources for routing data among nodes on TLN 120 and nodes on the array-level network (ALN) in each array 210 and 212.

TLN 120 may be a packet-switched mesh network using an array of TLN switches 251-256 for communication between agents. Various routing strategies may be used on TLN 120, depending on the implementation, but some implementations may arrange the various components of TLN 120 in a grid and use a row-column addressing scheme for the various components. Such implementations may then route a packet first vertically to the designated row, and then horizontally to the designated destination. Other implementations may use other network topologies and/or routing strategies for TLN 120.

Arrays 210 and 212 may include ALN links that may be similar to or a portion of ALN 113 (FIG. 1). ALN links 225-226 and 228-229 allow for communication between elements of array 210, elements of array 212, and through TLN 120 to shims of other functions of a CGR processor such as CGRP 106 (FIG. 1). Some examples of such shims include P-Shim 272, E-Shim 276, and M-Shim 279. In some implementations, P-Shim 272, E-Shim 276, and M-Shim 279 may be portions of interfaces 140 and 124 (FIG. 1). Other functions of CGRP 106 (FIG. 1) may connect to TLN 120 in different implementations, such as additional shims to additional and or different input/output (I/O) interfaces and memory controllers, and other chip logic such as CSRs, configuration controllers, or other functions. Data may travel in packets between the units of Arrays 210 and 212 on ALN links 225-226, 228-229, and the packets may travel to other elements external to Arrays 210 and 210 through TLN 120, for example through links 260-265. Top level switches 251 and 252 may, for example, be connected by ALN link 225, TLN switches 251 and P-Shim 272 may be connected by TLN link 260, TLN switches 251 and 254 may be connected by TLN link 261, and TLN switch 253 and M-Shim 279 may be connected by TLN link 264.

P-Shim 272 provides an interface between TLN 120 and PCIe Interface 273, E-Shim 276 provides an interface between TLN 120 and Ethernet Interface 277, which connects to external communication links 284 and 285 which may form part of communication links such as system data bus 146 as shown in FIG. 1. While one P-Shim 272 with PCIe interface 273 and associated PCIe link 284 are shown, implementations can have any number of P-Shims and associated PCIe interfaces and links. M-Shim 279 provides an interface to a memory controller 280. Controller 280 may be coupled to access a memory 281 which may include various types of memory, such as a high-bandwidth memory (HBM), a DDR memory, or other memory. Controller 280 may also have a memory interface 287 and can connect to other memory such as memory 128 of FIG. 1. While only one M-Shim 279 is shown, implementations can have any number of M-Shims and associated memory controllers and memory interfaces. Different implementations may include memory controllers for other types of memory, such as a flash memory controller and/or a high-bandwidth memory (HBM) controller. An implementation may include an interface for a non-transitory computer readable medium (CRM) 282. The interfaces for Shims 272, 276, and 279 include resources for routing data among nodes on TLN 120 and external devices, such as high-capacity memory, host processors, other processors of array(s) 210 and 212, other memory devices and so on, that are connected to the interfaces for Shims 272, 276, and 279. System bus 146 and TLN 120 (FIG. 1) can facilitate direct memory access (DMA) between host memory (such as memory 150 and/or 780 or 750 (FIG. 7)) and memory 281 or other memory within array 200, as well as facilitate direct communication between host 154 and either or both of Arrays 210 and 212.

One of the AGCUs in each CGR array in this example may be configured to be a master AGCU (MAGCU), which includes an array configuration load/unload controller for the CGR array. The MAGCU1 (for example AGCU 214) includes a configuration load/unload controller for CGR array 210, and MAGCU2 (for example AGCU 220) includes a configuration load/unload controller for CGR array 212. Some implementations may include more than one array configuration load/unload controller. In other implementations, an array configuration load/unload controller may be implemented by logic distributed among more than one AGCU. In yet other implementations, a configuration load/unload controller can be designed for loading and unloading configuration of more than one CGR array. In further implementations, more than one configuration controller can be designed for configuration of a single CGR array. Also, the configuration load/unload controller can be implemented in other portions of the system, including as a stand-alone circuit on the TLN and the ALN or ALNs.

Either one or both of CGR Arrays 210 and/or 212 and one or more portions of interfaces 270, including memory and Shims, may be formed on one or more semiconductor die. For example, Array 210 and switches 251, 254, and P-Shim 272 along with PCIe I/F 273 may be formed on a one semiconductor die, and Array 212 and switches 252-53 and 255-56, along with the remaining elements of interface 270 may be formed on a second semiconductor die. Both of the two semiconductor die may have a die-to-die interface, such as for example a portion of interface 148 (FIG. 1), that provides communication between the two die. Both die may be place onto one package as a hybrid of other type of configuration. For example, both die may be packaged as a dual die socket using chip-on-wafer-on-substrate (CoWoS) multi-chip packaging or other techniques.

A data processing operation or other method implemented by a CGR array configuration, such as Array 200, may comprise multiple Graphs or subgraphs specifying data processing operations that are distributed among and executed by corresponding CGRUs.

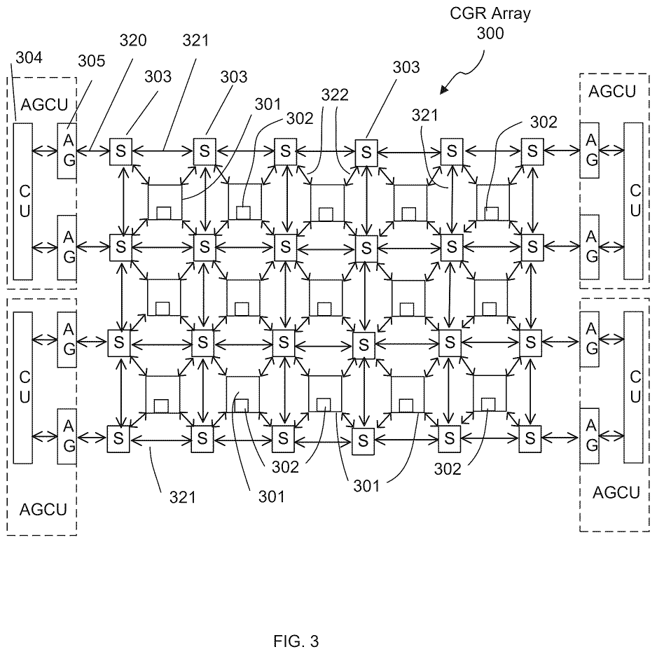

FIG. 3 illustrates an example of portions of an implementation of a CGR array 300, including an Array of CGR units (ACGRUs) connected in an ALN. The ALN may have an implementation that may be substantially the same as ALN 113 (FIG. 1). CGR array 300 includes one or more CGR units (CGRUs) 301. An implementation of CGR array 300 may have an embodiment that may be substantially similar to or alternately the same as Array 210 or Array 212 of FIG. 2, or alternately may be a portion of ACGRU 110 (FIG. 1).

CGR units (CGRUs) 301 may include a configuration store/logic circuit (Cfg) 302 that includes a set of storage and/or control logic, such as for example registers or flip-flops, that store configuration data. As explained hereinbefore, the configuration data may represent a setup and/or control sequence that may facilitate executing a Graph or a Process. Configuration store/logic circuit (Cfg) 302 may also include status information about the CGRU usable to track progress for execution of a Data-Flow graph or graph or sub-graph or other portion of the operation. Cfg 302 may further include the source operands, and/or the network parameters for the input and output interfaces. A configuration file may be stored within Cfg 302 and may include configuration data representing an initial configuration, or starting state of one or more of the CGRUs, or internal elements of the CGRU, that executes a graph or other high-level program with user algorithms and functions. Program load is the process of loading information from a compiler into different portions of a CGRP, such as for example CGRP 106 (FIG. 1). Program load may include loading parameters and initialization data into memory, such as for example into memory 128, or loading initialization information into the configuration file within the configuration store/logic circuit (Cfg) 302 with the information or data to facilitate the CGRU executing the graph or other the high-level program. Program load may also include loading memory units (MU) and/or PMUs. The configuration file defines a data flow graph including functions in the configurable units and links between the functions in the configurable interconnect. In this manner the configurable units act as sources or destinations of data used by other configurable units providing functional nodes of the graph. Such systems can use external data processing resources including external memory and a processor executing a runtime program, as sources or sinks of data used in the graph.

The ALN of CGR array 300 includes switch units or switches (S) 303, and also includes AGCUs that each may include two address generators (AG) 305 and a shared coalescing unit (CU) 304. Switches(S) 303 are connected among themselves via ALN interconnects 321 and are also connected to a CGRU 301 with ALN interconnects 322. Switches (S) 303 may be coupled with address generators (AG) 305 via ALN interconnects 320. Interconnects 320, 321, and 322 may have an implementation that may be a portion of the ALN within either of arrays 210 or 212 (FIG. 2) of ALN 113 (FIG. 1). In some implementations, communication channels can be configured as end-to-end connections, and switches 303 may be CGRUs. In other implementations, switches route data via the available links based on address information in packet headers, and communication channels established when needed. An initiating CGRU may be referred to as a source, requestor, initiator, or producer CGRU depending on the type of transaction. The source CGRU may initiate various types of transactions to various resources in a remote CGRU. The remote CGRU may be referred to as a destination, or sink, or consumer, or target CGRU. In some cases, the source CGRU may receive various responses from the destination CGRU.

The ALN of CGR array 300 includes one or more kinds of physical data buses, for example a chunk-level vector bus (e.g., 512 bits wide to transmit 512 bits of data), a word-level scalar bus (e.g., 32 bits wide to transmit 32 bits of data), and a control bus. For instance, ALN interconnects 321 between two switches may include a vector bus interconnect with a word wide bus width, for example 512 bits wide, and a scalar bus interconnect with a bus with a scalar word width, for example 32 bits wide, along with a control bus. The control bus can comprise physical lines separate from the data buses in some implementations. In other implementations, the control bus can be implemented using the same physical lines with a separate protocol or in a time-sharing procedure. A control bus can comprise a configurable interconnect that carries multiple control bits on multiple signal routes designated by configuration bits in the CGRU's configuration file in the configuration store/logic circuit (such as Cfg 302).

Physical data buses may differ in the granularity of data being transferred. In one implementation, a vector bus can carry a transmission that includes 16 channels of 32-bit floating-point data or 32 channels of 16-bit floating-point data (i.e., 512 bits) of data as its payload. An implementation of a scalar bus can have a 32-bit payload and carry scalar operands or control information. The control bus can carry control handshakes such as tokens and other signals. The vector and scalar buses can be packet-switched, where the packets may include headers that indicate a destination of each packet and other information such as sequence numbers that can be used to reassemble a file when the packets are received out of order. Each packet header can contain a destination identifier that identifies the spatial coordinates of the destination switch unit (e.g., the row and column in the array), and an interface identifier that identifies the interface on the destination switch (e.g., North, South, East, West, etc.) used to reach the destination unit.

Routing of packets on the vector and scalar networks may be done using 2D Dimension Order Routing (DOR) or using a software override using Flows. Flows may be used for multiple purposes such as to perform overlap-free routing of certain communications and to perform a multicast from one source to multiple destinations without having to resend the same packet, once for each destination. Sequence ID based transmissions may allow the destination of a many-to-one communication to reconstruct the dataflow order without having to impose restrictions on the producer/s. The packet switched network may provide end to end flow control and local flow controlled.

Each CGRU 301 may have four ports (as illustrated) to interface with switches 303, or any other number of ports suitable for an ALN. Each port may be suitable for receiving and transmitting data, or a port may be suitable for only receiving or only transmitting data. Switch (S) 303 may have eight interfaces. North, South, East, and West interfaces of a switch unit may be used for links between switch units using ALN interconnects 321. Northeast, Southeast, Northwest, and Southwest interfaces of a switch unit may each be used to make a link with a CGRU 301 using one of ALN interconnects 322. Two switches 303 in each CGR array quadrant may have links to an AGCU using ALN interconnects 320. The AGCU coalescing unit arbitrates between the AGs and processes memory requests. Each of the eight interfaces of a switch unit can include a vector interface, a scalar interface, and a control interface to communicate with the vector network, the scalar network, and the control network. In other implementations, a switch unit may have any number of interfaces.

During execution of a data-flow graph or graph or subgraph in a CGRP after configuration, data can be sent via one or more switch units and one or more interconnects between the switch units to the CGRUs using the vector bus and vector interface(s) of the one or more switch units on the ALN. A CGR array, such as for example Arrays 210 or 212, may include at least a part of CGR array 300, and any number of other CGR arrays coupled with CGR array 300.

CGRUs 301 can function as either a 2D systolic array or as a SIMD core. The 2D systolic array can accelerate general matrix multiply (GEMM) or similar operations. Matrix multiplication can be parallelized further across multiple CGRUs 301. As a SIMD core, CGRUs 301 can execute a parallel multidimensional tensor operation in a pipelined manner. In an implementation, each SIMD stage may include capability, such as for example circuits, to perform common arithmetic, matrix operations, matrix multiplication, complex arithmetic, logical, and bit-wise operations in various numerical representations and precision, such as for example 32-bit floating point (FP32), 16-bit brain floating point (BF16), and 32-bit integer (INT32) formats. Some SIMD implementations may also include capability to perform operations on 16-bit floating point (FP16) formats. In addition, CGRUs 301 can be optionally configured to implement a cross-lane reduction network. Lane-wise reductions can also be supported by CGRUs 301 in a typical SIMD manner. CGRUs 301 can include certain counters that track loop iterations and generate control events, such as when a counter reaches a programmed maximum value, indicating that a loop has completed execution, for example.

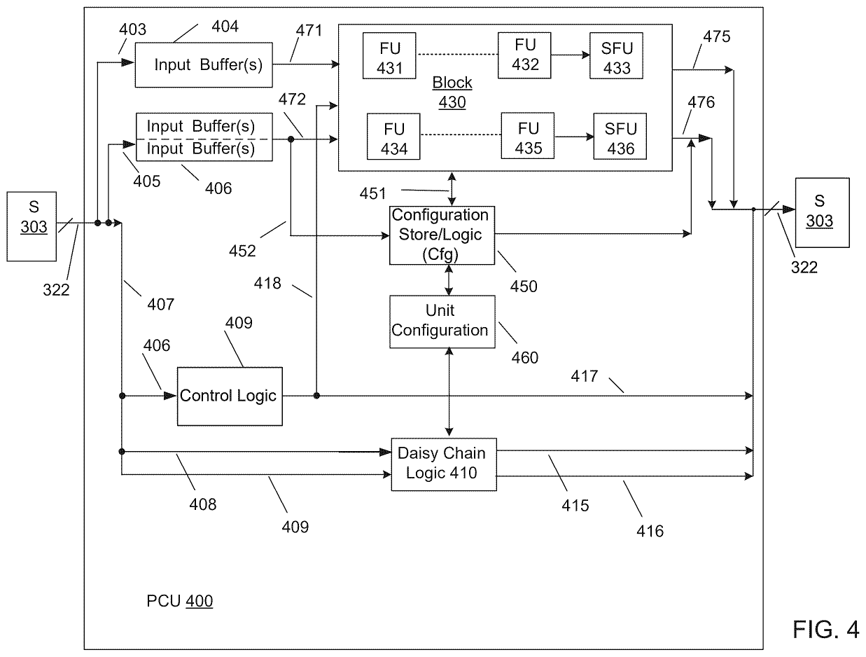

FIG. 4 is a block diagram illustrating an example of an implementation of a pattern compute unit (PCU) 400 that may be one or more of CGRUs 301 (FIG. 3). PCU 400 can interface with the scalar, vector, and control buses of the ALN, such as for example via interconnects 322 (FIG. 3). PCU 400 receives scalar inputs 403, vector inputs 405, and control inputs 407. Scalar inputs 403 can be used to receive at least single words of data (e.g., 32 bits). Vector inputs 405 can be used to receive chunks of data such as for example receiving vector data for one or more computations for pipelined operations within PCU 400 or across a pipeline between multiple PCUs, or may receive configuration data for configuring and controlling operations of PCU 400. Control inputs 407 can receive control signals that assist in operating PCU 400 or signals that may be passed along to other configurable units, such as via signals 415-417, external to PCU 400.

PCU 400 includes input buffers 404 and 406 that are connected to respective inputs 403 and 405 from respective data busses of ALN interconnect 322 (FIG. 3). Inputs 403 and 405 may have multiple signals and interconnects to support the multiple number of bits in the scalar and vector data paths of the respective data busses. Buffers 404 and 406 are used, among other things, to temporarily buffer incoming data. Using input buffers decouples timing between data producers and consumers and simplifies inter-configurable-unit control logic, such as for example by proving tolerance for delay mismatches. Buffer(s) 404 are configured to receive scalar data from inputs 403 via the scalar bus and may be FIFO type buffers or other known types of buffers. Buffer(s) 406 may be multiple parallel buffers to receive multiple vector data signals from inputs 405 via the vector bus and may be FIFO type buffers or other known types of buffers. For example, buffers 404 and 406 may be hardware storage elements, such as shift registers, etc. or may be static RAM memory that is controlled to function as a buffer, such as a FIFO buffer.

PCU 400 includes a compute block 430 that includes multiple reconfigurable data paths to assist in performing computation operations including pipelined computations. The reconfigurable data paths of compute block 430 includes functional units (FU) 431 through 436. In an implementation, FUs 431-436 may be configured as a multi-stage reconfigurable Single-Instruction, Multiple-Data (SIMD) pipeline. FUs 431-436 may, in some implementations, be configured as a plurality of parallel chains wherein each chain is configured with multiple serially connected FUs. For example, FUs 431-433 may be configured as one chain of serially connected FUs, and/or FUs 434-436 may be configured as one or more parallel chains of serially connected FUs, or combinations thereof. An implementations of block 430 may include a special functional unit (SFU) 433 and 436 as a configurable module that includes sigmoid circuits and other specialized computational circuits, the combinations of which can be optimized for particular implementations. In one implementation, a special functional unit can be at the last stage of a multi-stage pipeline and can be configured to receive an input line from other functional unit(s) (e.g., 432, 435) at a previous stage in a multi-stage pipeline. Although block 430 is illustrated with two SFUs 433 and 436, a PCU can include many sigmoid circuits, or many special functional units which are configured for use in a particular dataflow graph, such as by configuration data.

PCU 400 also includes a configuration store/logic circuit (Cfg) 450 that may have an implementation that may be similar to cfg 302 (FIG. 3). A control logic block circuit or control logic 409 is also included within PCU 400. Control logic 409 receives at least a portion of the control signals on control inputs 407. Control logic 409 may also provide control outputs 418 that may be used to assist in the operation of block 430. Control logic 409 may also form control signals 417 that may be transmitted to other configurable units via interconnects 322. A unit configuration load logic circuit or logic 460 of PCU 400 may function with cfg 450 to assist in controlling some of the operations of PCU400. Logic 460 and cfg 450 may receive configuration data, such as for example data/instructions, as a portion of the unit configuration load process described hereinbefore, or may receive the configuration data from other operations. Logic 460 and cfg 450 may receive the configuration data as chunks of a unit file (e.g., via vector inputs 405 and buffersn406) that is particular to how PCU 400 may be used in a graph, the configuration data may be loaded into cfg 450 and logic 460. The configuration data for cfg 450 and logic 460 may be received via inputs 405 to buffer(s) 406 and transferred from buffer(s) 406 to logic 460 and cfg 450. The configuration data may include opcodes, operation sequences, and routing configuration for circuits, such as for example for implementing a matrix multiply, a pipelined matrix multiply, or other pipelined operation. The configuration data stored to cfg 450 may include configuration data for each stage of the reconfigurable data path in block 430, for example via connection(s) 451.

An implementation of cfg 450 and or logic 460 may include serial chains of latches, where the latches store bits that control configuration of the resources in the configurable unit. A serial chain may also include a shift register chain for configuration data and a second shift register chain for state information and counter values connected in series.

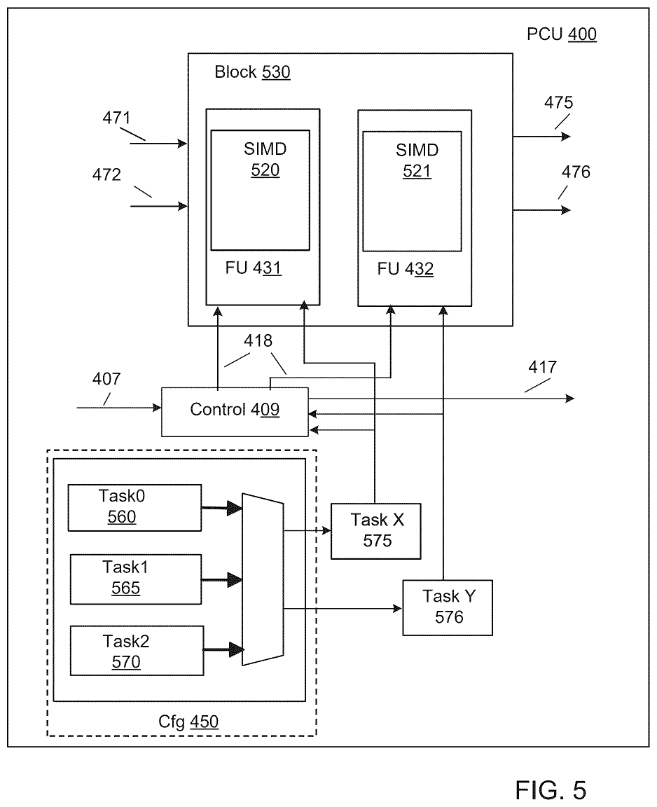

FIG. 5 illustrates a portion of an example of an implementation of some of the functional units (FUs) of block 430 (FIG. 4). For purposes of illustration and for simplicity of the drawings, only two FU(s), FU 431-432, are illustrated. However, any one of FU(s) 431-436 may include similar elements. FU(s) 430-431 are illustrated to include a SIMD ALU or SIMD 520 and 521, respectively. SIMD 520 or 521 can be an example of a portion of any one of the FU(s) of block 430 (FIG. 4). FU(s) 431-432 may receive any of outputs 471 and 472 from respective buffers 404 and 406. FU(s) 431-432 may also receive control outputs 418 from control 409. FU(s) 431-432 may assist in forming outputs 475-476. Referring to FIG. 3, various PCUs of CGRUs 301, may also include similar configurations similar to block 430.

In one embodiment, PCU 400 may be coupled to receive configuration data for cfg 450 that may include multiple tasks, illustrated in a general manner by task0 560, task1 565, and task2 570. The configuration data loaded into cfg 450 can be one example of the configuration data formed by system 100 (FIG. 1). In one example, PCU 400 may be coupled to perform the multiple tasks task0 560, task1 565, and task2 570 in any order depending on the requirement of the dataflow graph and to configure a data path to perform the task. For example, PCU 400 may be configured, such as by the configuration data in cfg 450, to form a data path to perform taskX 575 and taskY 576. The datapath configured can include one or more of functional units (FUs) such that they allow either of or both of SIMD 520 and/or 521 to perform multiple operations with a single instruction. Thus, the single task taskX 575 can include multiple operations, and taskY 576 may include multiple operations. TaskX 575 and taskY 576 may be performed by respective SIMD 520 and 521. The two tasks can be at different stages of completion depending on the complexity of the task. When one of tasks 575 or 576 is complete, cfg 450 may cause PCU 400 to form a datapath to perform task0 560. PCU 400 can be programmed to load a particular task0 560-task 2 570 from one of the available tasks in cfg 450. Switching between the tasks can be pre-programmed into cfg 450 by the configuration data, such as for example to switch from task0 560 to task1 565 to task2 570 and loop back as desired.

The progress of any task can be tracked, for example using one or more counters. In one example, when a counter reaches a pre-programmed maximum value a “done” event can be generated. Such events can be used to control the program flow in CGRP 106 (FIG. 1).

Referring to FIGS. 4 and 5, in an implementation of a multi-stage pipeline, stages of the pipeline may include input registers or data stores that hold or stage input data at a first part of a cycle (e.g., a leading edge of a clock pulse), and output registers or data stores that stage output data of the stage at a next part of a cycle (e.g., a leading edge of the next clock pulse, for example one pipeline clock period). At the time of the first part of the cycle, the output registers of the stage hold the stage output data of the previous pipeline cycle, and the stage output data of one stage in the pipeline is at least part of the stage input data of the next. Thus, the pipeline can execute operations without storing the result of an operation in a memory because the data for the next part of the cycle is at the output of the previous pipeline stage. A pipeline cycle can be less than a nanosecond in some implementations.

An implementation of a graph may configure one or more of FUs 431-436 into a multi-stage pipeline to perform various manipulations on one or more matrices of BF16 or FP32 data. The graph may also have an implementation that may configure the pipeline for various manipulations on one or more matrices of INT32 or FP16 data. The manipulations may include, among other things, matrix multiplications or additions or other operations. An implementation may include that a graph may configure one or more of FUs 431-436 to repetitively perform matrix multiply operations on data received from buffers 406. For example, one of FUs 431-436 can be configured to compute an inner product of a row of a matrix A and a column of a matrix B such that different row/column combinations may be computed by different ones of FUs 431-436. The completed result may be used by one of FU 431-436 of may be sent to a different PCU in a pipeline for further computations without being stored in memory, or alternately may be stored in a PMU and later sent to a PCU for further computations. One example of a PCU configured for multi-stage pipelined operations including matrix multiplications may be found in U.S. Pat. No. 11,442,696 B1 entitled “Floating Point Multiply-Add, Accumulate Unit With Exception Processing”, filed on Nov. 23, 2021 and issued on Sep. 13, 2022 which is hereby incorporated herein by reference.

CGRP 106 may also utilize multiple connected PCUs to perform pipelined operations as described in U.S. Pat. No. 12,443,471 B2 entitled “System and Method For User Interactive Pipelining of a Computing Application” which was filed on Dec. 22, 2022 and issued on Oct. 14, 2025, which is hereby incorporated herein by reference.

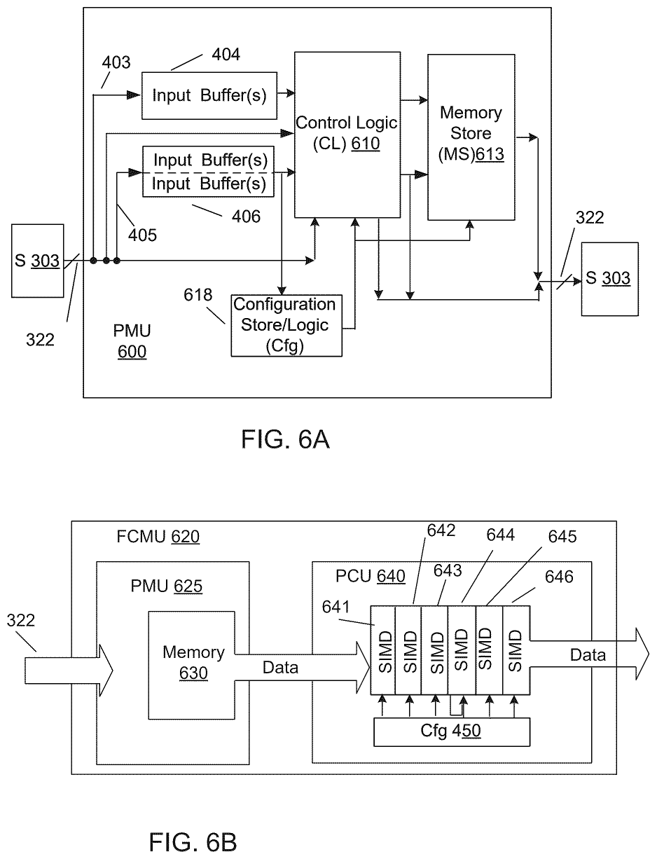

FIG. 6A illustrates a simplified block diagram of an example of an implementation of a pattern memory unit (PMU) 600 that may be substantially the same as one or more of CGRUs 301 (FIG. 3) and that may operate substantially the same as one or more of CGRUs 301. PMU 600 includes a simplified example of an implementation of a configuration store/logic circuit (cfg) 618 that may be substantially the same as or may operate substantially the same as Cfg 302 (FIG. 3) or Cfg 450 (FIG. 4). PMU 600 may also include control logic (CL) 610 that may assist in operating the elements of PMU 600.

PMU 600 includes a memory storage area or memory store circuit or memory store (MS) or MS 613 that may be configured as any type of memory of any size including SRAMS, DRAMS, flip flops, etc. An implementation of memory store (MS) 613 may be used as a memory store to sequence the reading of data that is received by a system that includes CGR array 300 (FIG. 3) such as for example CGRP 106 (FIG. 1). MS 613 may in some configurations be a scratchpad memory. For example, MS 613 may be an implementation of at least a portion of memory 116 of ACGRU 110 (FIG. 1). PMUs can be used to distribute on-chip memory throughout the array of reconfigurable units, such as ACGRU 110. In one implementation, address calculation for the memory in the PMUs is performed on the PMU datapath, such as by CL 610, while the core computation may be performed within a PCU. Each word of memory in PMU 600 may have any number of bits. An implementation may include words having 128 bits per word. A single logical tensor can span multiple PMUs 600 due to capacity, throughput bandwidth, or both. PMU 600 can facilitate spanning a tensor over multiple PMUs 600 by providing logic and control to programmatically control tensor address interleaving across PMUs. For example, PMU 600 may be programmed with a range of valid addresses for one instance of PMU 600. Alternatively, PMU 600 can support a programmable predicate bit per generated address. An address may be processed by PMU 600 if the address is within a programmed range or a valid predicate, otherwise the address may be dropped by PMU 600.

FIG. 6B illustrates a simplified block diagram of an example of an implementation of a Fused Compute Memory Unit (FCMU) 620. FCMU 620 includes one or more PMU(s) 625 and one or more PCU(s) 640 that are combined into FCMU 620. PCU(s) 640 may be one or more implementations of PCU 400, and PMU 625 may be one or more implementations of PMU 600. PMU 625 may be directly coupled to PCU 640, or optionally via one or more switches. PMU 625 includes a memory store circuit 630 that may be substantially the same as MS 613 (FIG. 6A). PCU 640 includes two or more functional units, such as SIMD 641 through SIMD 646 that may be substantially the same as any one or more of FU(s) 431-436 (FIG. 4) or any one or more of SIMD 520-521 (FIG. 5).

FIG. 7 is a simplified block diagram illustration of an example of an implementation of a host computer system or host 700 including a host computer processor 720, and a host storage 780. Host 700 may have an implementation that may be an alternate implementation of host 154 (FIG. 1). Host 700 includes a processor 720 and memory/storage element or storage 780. Although host 700 is drawn with a single processor 720, and a single storage 780, other implementations may have multiple processors. Storage 780 may include a memory 750 and may include a non-transitory computer readable medium (CRM) 752.

Processor 720 may have a typical Von-Neuman architecture and may include an ALU 724, a memory 726, and control logic 722. Processor 720 may further include an I/O interface (I/F) 739, and a network interface 748. Processor 720 may have other architectures in other implementations. Processor 720 may be coupled with I/O interfaces (I/F) 739 and may include an internal data bus 725. Storage 780 communicates with I/O interface 739 and memory 726 via a system bus 785. Processor 720 may further include other computational elements, such as a control program or program 730, and other memory units (not shown) that may be connected with system data bus 785 and internal data bus 725 to provide the circuitry for execution of computer program instructions, such as for example compiler 732. In an implementation, host 700 may be host 154 (FIG. 1) and may communicate with CGRP 106 via network 710 through communication interface 148.

FIG. 8 illustrates of an example of at least a portion of an implementation of a complier system or compiler stack 800 that may be used to compile dataflow graphs for a reconfigurable dataflow architecture, such as for example CGRP 106 (FIG. 1). Stack 800 illustrates in a general manner some various functional elements that may be utilized to convert high-level programs and software into executable files for the reconfigurable dataflow architecture. Stack 800 includes a number of stages to convert high-level code expressions, including user supplied code and mathematical expressions/functions, into configuration instructions and graphs for the reconfigurable dataflow architecture. The resulting dataflow graph may configure the reconfigurable dataflow architecture as a dataflow processor having pipelined execution stages. Stack 800 illustrates some functions that may be involved during an example of an implementation of a method of compiling the dataflow graph. Stack 800 may have other functions in other implementations. Some of the various elements of the compiler stack may include libraries and data structures illustrated with arrows indicating contribution of the elements.

Stack 800 may have an implementation that includes a dataflow (DF) compiler 822, high-level model(s) 840, an application flow (AF) compiler 810, and a software application specific interface (API) stack or software stack 812. As will be seen further hereinafter, DF compiler 822 is configured to integrate and compile different software applications into at least portions of a dataflow graph capable of execution on a system that has a reconfigurable dataflow architecture, such as system 100 or CGRP 106 (FIG. 1), or alternately on other systems and processors. For example, DF compiler 822 can be executed on host 154 (FIG. 1) or host 700 (FIG. 7) to form dataflow graphs for execution on system 100 or CGRP 106 (FIG. 1), including configuring the pipelined execution stages.

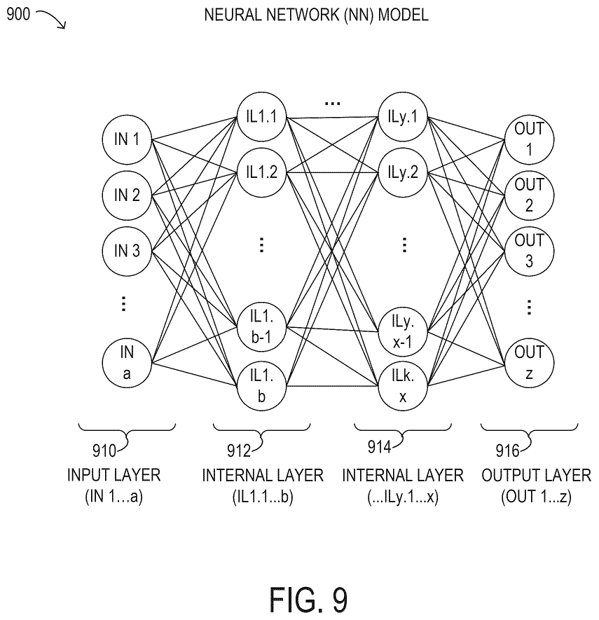

One or more of model(s) 840 may include the source code for various types of models such as AI/ML/LLM models, including open source models and proprietary models. For example, model(s) 840 may include models known as DeepSeek, Llama, gpt-oss, Whisper, GPT-40, etc. The various models are illustrated in a general manner by models 841, 842, through 840-N. One or more of model(s) 840 may include a set of procedures, such as learning or inferencing for an AI or ML or LLM system. Model(s) 840 may include applications, graphs, user applications, computation graphs, control flow graphs, dataflow graphs, deep learning applications, learned parameters for the model, deep learning neural networks, programs, program images, jobs, tasks and/or any other procedures and functions. In some implementations, execution of the graph(s) or sub-graphs for model(s) 840 may involve using multiple units of CGRP 106 (FIG. 1), for example multiple PCU's. One or more models 840 may include AI/ML/LLM models having various versions capable of processing from approximately five billion (5B) learned parameters to approximately six hundred billion (600B) learned parameters. One or more of model(s) 840 may represent a NN-based model, such as an LLM, that may be configured by DF compiler 822 to operate on CGRP 106 (FIG. 1). Model(s) 840 may represent a source of data describing or defining at least apportion of the NN-based model, such as for example a model functionality similar to NN 900 (FIG. 9), which may be defined using, for example, multiple 2-D tensors of weighting coefficients (wi), among other values.

FIG. 9 illustrates an example of a model of an implementation of a neural network (NN) 900. NN 900 may have an implementation that may be the NN-basis for one or more of model(s) 840 (FIG. 8). NN 900 is illustrated as a neural network architecture having an input layer 910, internal layers 912 and 914, and an output layer 916. CGRP 106 (FIG. 1) may, in some implementations, implement some operations illustrated by NN 500. Some implementations of some ML's, LLM's, and AI models, and other models may utilize logic that may be similar to NN 900. In mathematical processing using NN 900, the processing at each layer can be represented by an activation function that can be generalized by Equation 1.

$$y = Σ\_i \text{?} 〚 ( w\_i x\_i ) + b 〛 \qquad Equation 1$$

Where: y is an output value; i represents an index variable or dimension for each layer input; xi represents the input value at each neuron (such as from another neuron); wi represents a weighting coefficient applied at each neuron; and b represents a constant for each neuron.

In an implementation, the output of each neuron of NN 900 can be represented by output value y of Equation 1. The process of activation of each internal layer is generally known as feedforward activation, which characterizes the typical use of a neural network to receive input and generate output. Feedforward may occur over multiple timesteps and may involve the use of externally generated data that may in some implementations be referred to as “tokens”, internally generated data, or both. The use of feedforward activation within NN 500 to generate output (separate from feedback, backpropagation, and other types of training) may also be known as “inference”.

Although NN 900 is depicted with a certain set of nodes or artificial neurons (referred to herein as simply “neurons”), NN 900 may have various dimensions and structures. For example, NN 900 can be expanded to any number of input neurons, w number of input layers each having b through x number of neurons respectively, and z number of output neurons. Parameters a, b through x, w, and z can each have different dimensions, such as 103, 106, 109, 1012, among other values in various implementations. Although a single network is illustrated, NN 500 may have different numbers of networks, such as by implementing a branched or otherwise structured topology.

Optimization algorithms for MLs, LLMs, and AI models can be useful for training the models by minimizing error between a predicted output and target values. Some optimization algorithms may be iterative optimization algorithms used to minimize a “cost function” (also referred to as a “loss function”), which quantifies an error or a difference between a model's predicted value (or draft value) and a target value (prefill value). The optimization may operate by adjusting the parameters of the model to reduce the error over multiple iterations. Reconfigurable Data flow architectures, such as CGRP 106 (FIG. 1) may improve computation for training of the MLs, LLMs, and AI models.

Referring back to FIG. 8, application flow (AF) compiler 810 converts user algorithms, user source code, functions, etc. into dataflow graphs or sub-graphs that may be configured for operation on CGRP 106, or for conversion by DF compiler 822. The user algorithms and functions and source code may be developed in high-level program languages. This allows users/programmers to provide code that can be stitched or woven into the code from other software such as stitched into the code from model(s) 840 or from stack 812, or that runs directly on the reconfigurable dataflow architecture. For example, AF compiler 810 may include compilers and/or libraries for high level software languages to convert/compile user algorithms written in languages such as PyTorch, TensorFlow, ONNX, Caffe, Keras, C++, or other high level software languages. Compiler 810 may also allow users to supply configuration instructions to DF compiler 822 that directs compiler 822 to replace some of the algorithms or graphs of model(s) 840 with user supplied algorithms or graphs. AF compiler 810 may also include at least some software functionality that may be defined by parameters for model(s) 840. The parameters and other source code may be stored as portions of files to be compiled by DF compiler 822 along with one or more of model(s) 840 and/or the code from AF compiler 810. Alternately, the parameters and source code may be loaded into portions of software stack 812.

Software stack 812 may include various application specific interface (API) function libraries configured to support the reconfigurable dataflow architecture, such as for example CGRP 106. For example, stack 812 may include source code for various libraries and/or source code for sub-graphs for model(s) 840 that can be compiled into an executable form. In some cases, code elements can be added or integrated as options or features in AF compiler 810. The API function libraries may include a software API 814, a software abstraction layer (SAL) API 816, a hardware abstraction layer (HAL) API 818, and a collective communication library (CCL) 819. API function libraries (814, 816, 818, 819) included with software stack 812 can define a so-called “application stack” using the system-level function libraries for CGRP 106 that facilitate executing any of model(s) 840 on CGRP 106. Software stack 812 can accordingly be implemented for a specific application and include sub-graphs that can be added to model(s) 840 and/or into AF compiler 810.

Software API 814 and API 816 may include software for system functions that can be called by user code or other code that need to use the function, such that the function can be integrated into the graphs formed by AF compiler 810 or DF compiler 822. For example, API 814 may include code for mathematical functions or other functional software, such as parameters or instructions to, among other things, perform operations for model graph tracing, for merging sub-graphs from model(s) 840 or from AF compiler 810 with model(s) 840, or for initiating execution of model(s) 840. Selection of various portions of software stack 812 can depend on a hardware environment or operating system environment used for the reconfigurable dataflow architecture. API 818 may include hardware specific functions such as a definition or topology of the configurable units within CGRP 106 or ACGRU 110 (FIG. 1). For example, the topology of the PCUs/PMUs, within CGRP 106. CCL 819 may be used for supplying parameters that may be used by ones of mode(s) 840 or other software during execution on CGRP 106. For example, CCL 819 may supply parameters for a number of iterations that the resulting model may make before providing an output.

DF compiler 822 represents a software tool executable on a host, such as for example host 154 (FIG. 1) or host 700 (FIG. 7), to generate one or more executable file(s) 830 and one or more data files or data 835 that result from compiling into a format that is specific for the reconfigurable dataflow architecture, such as for example CGRP 106. Executable file(s) 830 and data 835 can be used to execute one or more of model(s) 840 or other software on CGRP 106, as also defined or compiled by software/code from AF compiler 810 and stack 812.

DF compiler 822 may include a graph compiler 824, a functions compiler 826, and a compiler library 820. Graph compiler 824 processes data from model(s) 840, data from stack 812, the results (such as graphs and sub-graphs) from AF compiler 810, and generates code for one or more dataflow graphs for the reconfigurable dataflow architecture. Graph compiler 824 may be configured to make high-level mapping decisions for the graphs and sub-graphs based on the hardware constraints of the configuration of CGRP 106. Function compiler 826 is configured to translate high-level software for various functions including arithmetic functions into graphs or sub-graphs that are compiled by graph compiler 824. Function library 820 may include a set of operator kernels that supports both graph compiler 824 and function compiler 826. Library 820 can be specifically optimized for the reconfigurable dataflow architecture. DF compiler 822 also generates the configuration files (Cfg, see FIGS. 1 and 3) with configuration data (e.g., a bit stream) for the placed positions of the units in CGRP 106.

Compilers 824 and 826 may also be configured to perform stitching or weaving to merge graphs/sub-graphs such as merging graphs/sub-graphs of model(s) 840 and graphs/sub-graphs created from AF compiler 810, graphs of user supplied software. Compilers 824 and 826 may also perform resource usage estimates, perform tiling and topology allocation on CGRP 106, and other operations. Compilers 824 and 826 translate graphs/sub-graphs to the physical topology of the reconfigurable dataflow architecture, including conduct place/route of the hardware resources, and making bandwidth calculations. Compilers 824 and 826 may be configured to analyze the dataflow graphs of model(s) 840 and determine progress milestones (or execution boundaries) for operations in the dataflow graphs, and may also layout/construct pipelines based on mapping decisions from AF compiler 810, including placing operations into a meta-pipeline and, if needed, inserting stage buffers into the pipeline. Compilers 824 and 826 may also further optimize operations including pipeline collapsing and fusing of some software operations, and may also reconfigure model 840 graphs with other logical flow elements, such as replacing one or more model 840 sub-graph(s) with one or more hardware specific sub-graphs and/or merging sub-graphs from AF compiler 810. The source code for the hardware specific sub-graphs may be in AF compiler 810 or in stack 812, such as for example from API 818. For example, compilers 824 and 826 may examine the number of tensors or the size of the tensors in the parameters of model(s) 840 and receive user commands to select different graphs for different ones of the model graphs/sub-graphs or user graphs/sub-graphs based on the tensor sizes. For example, may evaluate the size of the sequence numbers of the tensors to make the determination the number or size of the tensors. Compiler 822 can configure the hardware of CGRP 106 to provide pipelined processing of data and other elements such as explained in the descriptions of PCU 400 (FIGS. 4 and 5) and through pipelined processing in multiple PCUs as explained in the description of FIG. 5.

In some implementations one or more of model(s) 840 may include logical flows for matrix data operations, or linear operations, or other mathematical operations on matrix data or other data of model(s) 840. DF compiler 822 may also include functionality for model-level graph transformation and various optimizations. For example, graph compiler 824 may merge graphs from AF compiler 810 and/or from stack 812 with graphs from model(s) 840 to form compiled dataflow graphs that modify some of the operations of model(s) 840 or to fit the configurable units of the reconfigurable dataflow architecture, or may stitch graphs of stack 812 with graphs of model(s) 840 into compiled dataflow graphs and execution schedules for execution on the reconfigurable dataflow architecture, such as on CGRP 106. Some of the compiled configuration files and execution file data for the reconfigurable dataflow architecture may be included in files 830 and/or data 835. For example, some of the data from model(s) 840 may be included within data 835. Post compilation, the executable dataflow graphs in files 830 and data 835 may be loaded into CGRP 106 for execution thereon. Execution of a dataflow graph on CGRP 106 or ACGRU 110 may comprise multiple graphs or multiple sub-graphs specifying data processing operations that are distributed among and executed by corresponding multiple CGR units (e.g., PMUs, PCUs, FCMUs, AGs, and CUs).

A runtime logic 850 may be configured to load files 830 and data 835, including the compiled dataflow graphs, and configure the array of configurable units, such as for example ACGRU 110 of CGRP 106, to execute the dataflow graphs. Runtime logic 850 may operate on the host (such as host 154 in FIG. 1) to load files 830 and data 835 including the configuration data for the configurable stores (Cfg) in the array of configurable units such as CGRP 106 and/or ACGRU 110.

One or more of model(s) 840 may be configured to, for example the graph(s) of model(s) 840 may be configured to, perform several different types of tasks or operations. In some implementations, one task may utilize a large amount of processing operations or large amount of processing resources, such as for example processing time or hardware, to perform the task (which is referred to herein as “compute bound”), and another task may utilize a large amount of memory space or use a large number of memory operations (such as for example read and/or write operations to/from memory) to perform the task (which is referred to herein as “bandwidth bound or B/W bound”). In some implementations, one or more of models 840 may have both B/W bound tasks and compute bound tasks, or combinations of two or more of models 840 may have one model with B/W bound tasks and another model with compute bound tasks.

In one example implementation, one or more of model(s) 840, such as for example model 841, may be an LLM, such as the source code for the LLM, that may be used to perform inferencing or speculative decoding of input data from a user. For performing the inferencing, the model may be configured to receive the input data from the user, such as for example a question from a person external to system 100 that is using an input device, and to speculate additional data back to the user based on the input data. In some implementations, the input data may include an image or pixels of an image. The model may be an LLM that has a large number of learned parameters, such as for example from approximately five billion (5B) parameters to approximately six hundred (600B) learned parameters. The learned parameters may be included as a portion of model(s) 840 or within stack 812, etc.

The model may be an LLM configured to convert the input data from the user into data tokens that represent words, or sub-words, or characters, or pixels or other elements that represent the input data. Thus, a data token may represent one word in a phrase or a sub-word, or one or more characters of a word, or other portions of a word in a phrase or a portion of an image. The data token or tokens are well known elements used for representing or evaluating data. As used herein, the word data token as referring to speculative decoding or inferencing may be taken to refer to the one or more data tokens that result from the conversion of words or image(s). An implementation may include that each data token may also include one or more keys and one or more values for each data token. The keys and values are well known parameters that are used for representing and evaluating data, such as an evaluation by an LLM. The model may be configured to store the keys and values in a k, v cache (“k/v cache”) within memory of the system, such as for example CGRP 106. In one implementation, the source code for the model may initially include an initial k/v cache for the model which may initially be stored in stack 812, or as a portion of the data for compiler 810 or as a portion of model(s) 840. After compiling, the data for the cache may be stored in memory of system 100, such as memory 150 or 128, during a program load operation (see FIG. 3 description) or alternately as a portion of a program initialization.

The model may include one or more graphs or sub-graphs that are configured to receive the user input data and to generate or speculate draft data tokens that may be used for the inferencing, this speculation of data may be referred to as “prefill”. One or more of the model graphs may also be configured to verify the probability that the draft data tokens or prefill data tokens may be accepted by the user, for example using the k/v cache data to assist in evaluating the prefill data tokens and determining the probability. This is often referred to as verification or “decode”. The model data such as the model parameters, and in some implementations including the k/v cache data, may require a large amount of memory for storing the model data. As will be seen further hereinafter, the model graph for the decode task may be B/W bound, while the prefill tasks or other tasks of the model may be compute bound. The initial elements of the learned parameters and/or the k/v cache and/or other data for model(s) 840 may initially be stored in memory that may be external to ACGRU(s) 110 (FIG. 1) or array 200 (FIG. 2) of CGRP 106. For example, some of the data for model(s) 840 may initially be stored in memory 150 or 128 (FIG. 1).

In an implementation, the data for one or more of model(s) 840, such as for example the learned parameters or k/v cache data, other data, may be in a format that is not supported by the reconfigurable dataflow architecture, for example not supported by the hardware of CGRP 106 or by ACGRU 110. For example, CGRP 106 may have an implementation that may be devoid of hardware that is capable of processing data that is in an 8-bit floating point (FP8) format but may include hardware capable of processing other data formats and mathematical operations, including matrix manipulations and matrix multiplication, using such as for example one or more of 32-bit floating point (FP32) or 16-bit brain floating point (BF16) or 16-bit floating point (FP16) or 32-bit integer (INT32) formats. For example, CGRP 106 (FIG. 1) and/or block 430 of PCU 400 (FIG. 4) may include hardware capable of pipelined parallel processing of various operational flows using FP32 or BF16 or FP16 format. In order for CGRP 106 to use the data for model 841, the data has to converted to a format that is supported by CGRP 106.

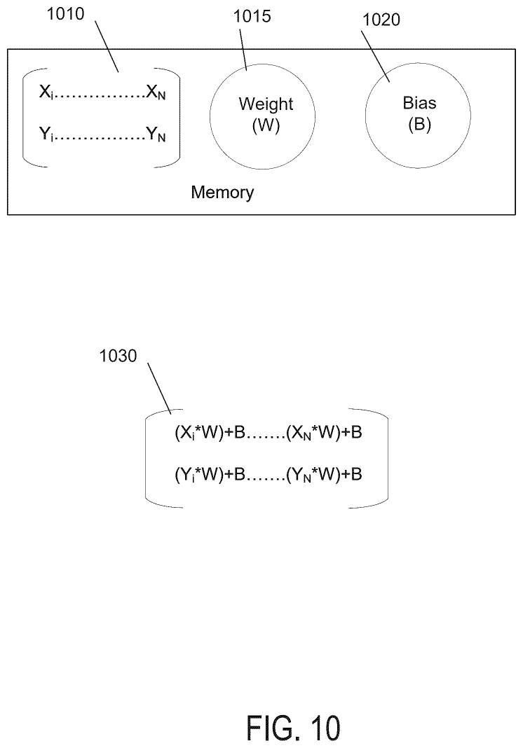

FIG. 10 illustrates in a general manner a quantized tensor matrix that may be stored in memory, such as for example memory 128 (FIG. 1). A dequantization operation for dequantizing the data of matrix 1010 is also illustrated in a general manner. Matrix 1010 represents data that has been quantized from a high precision format to a lower precision format. Matrix 1010 has quantized values in rows and columns represented by a row having data Xᵢ to X_{N}, and a row having data Yᵢ to Y_{N}. Although only two (2) rows are illustrated, matrix 1010 may have a large number of rows. The quantized data also includes a weight value or weight (W) 1015, and a bias value or bias (B) 1020. The dequantization process involves a matrix multiplication of the individual elements of matrix 1010 by weight 1015, and a subsequently add of bias 1020 to each resulting value. A dequantized matrix 1030 illustrates an example of the math used to form the dequantized data.

Consider for example, a system that includes graphs that incorporate one or more of models, such as for example one or more of model(s) 840, and wherein model data for the model(s) may be stored in memory that is not physically within the main processor of the system. The model data may include model learned parameters and in some implementations may include other data such as for example k/v/cache data. The prefill operation may include using the model data to process multiple draft data tokens thereby performing a large number of computations resulting in a compute bound operation. The decode operation may include using the model data, and in an implementation k/v/cache data or previously calculated k/v cache data, to verify the draft data tokens from the prefill operation. The decode operation may use fewer computations than the prefill so the system may be slowed waiting to receive some of the model data from memory. Thus, the decode operation may be B/W bound.

It has been found that the overall performance of the reconfigurable dataflow architecture, such as for example CGRP 106 (FIG. 1), is improved by a method that manages at least some of the compute bound tasks in a different manner than at least some of the B/W bound tasks. A method of forming a dataflow graph that includes one or more of model(s) 840 may include a graph for the B/W task that operates in one manner and a separate graph for the compute task that operates in a different manner. As will be seen further hereinafter, having separate B/W graphs and compute graphs improves the overall speed of performing the task(s) for CGRP 106 and for model(s) 840.

It has been found that for the B/W bound tasks, such as for example the decode/verification task, it is more efficient to fuse the task of dequantization of model data with subsequent tasks. Fusing the tasks means that the data is processed by the pipeline configuration of CGRP 106 and not stored in memory in-between the operations of the tasks. Thus, for the B/W tasks, CGRP 106 is configured with a pipeline architecture that performs the dequantization of the model data followed by subsequent operations, such as the decode operations, without storing the dequantized data into memory, such as not into memory on CGRP 106 or memory of ACGRU 110. An implementation may include that the dequantized model data is not stored in a storage element that is external to the pipeline. For example, the dequantization and subsequent operations may be processed through pipelines within one or more PCUs of CGRP 106 without storage in PMUs or other memory. For the compute bound tasks, such as for example the prefill tasks, CGRP 106 is configured with a pipeline architecture that includes PCUs and memory, such as for example PMUs or other memory of ACGRU 110 (FIG. 1). The dataflow graph(s) control CGRP 106 to perform dequantization of the model data within the pipeline followed by storing the dequantized data into memory, such as for example memory within the pipeline or other memory of ACGRU 110. Subsequently, the data is read from the memory and used for performing other operations, such as the prefill tasks. An implementation may include that CGRP 106 receives the user input data and generates or speculates possible prefill data tokens (or draft tokens or prefill tokens) that may be used for the inferencing and stores the prefill data tokens in memory between operations.

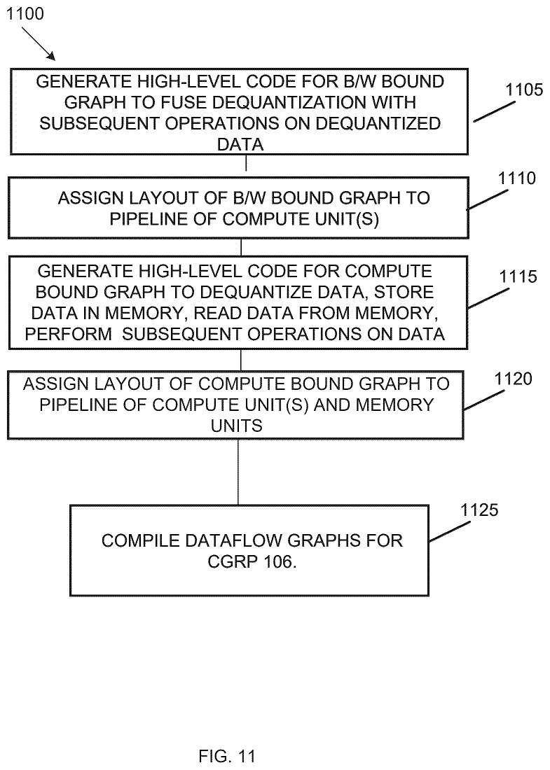

FIG. 11 a flowchart 1100 illustrating some general steps in a method of creating a dataflow graph for a coarse grained reconfigurable processor, such as for example CGRP 106 (FIG. 1) wherein the dataflow graph includes separate graphs for different tasks, such as for example separate graphs for B/W bound tasks and compute bound tasks. At a step 1105, a user, such as a system manager or software engineer, writes software to instruct compiler 822 to configure a B/W graph for B/W bound operations of one or more of model(s) 840 that have B/W bound tasks. The user may write high-level code that fuses the dequantization task with subsequent tasks that may be B/W bound, such as the decode tasks. For example, compiler 822 may be instructed to examine the sequence number of the tensors of some of the parameters of the model to determine if a graph may be B/W bound. For example, large sequence numbers may indicate that an operation includes B/W bound operations. An example of at least a portion of such a high-level code for a B/W bound sequence may include:
For i in [0, n−1]
   Output token[1+1], updated KV cache=decode graph(weights, KV cache, Output token[i])

At a step 1110, the user writes high-level code to instruct compiler 822 to configure the topology of CGRP 106 to constrain operation of the B/W operations to be performed in a pipeline without storing data in memory, such as for example form a pipeline of PCUs. The code sequence may include:
Load: (TP x, PP y, Sharding z, Operator par 1)
Lin (internal Deq): (TP x, PP y, Sharding z, operator par w).

At a step 1115, the user writes high-level code to instruct compiler 822 to configure a compute graph for compute bound tasks of one or more of model(s) 840 that have compute bound tasks. The user writes high-level code that separates the dequantization task with subsequent tasks, such as the prefill tasks of the model. For example, compiler 822 may be instructed to examine the number of tensors, or the sequence number of the tensors of some of the parameters of the model, or the number of computations in each task or operation of the graph to determine if a graph may not be B/W bound. For example, large sequence length or large sequence numbers may indicate that an operation includes compute bound operations. An example of at least a portion of such a high-level code for a compute bound sequence may include:
Output token[0], KV cache=prefill graph(weights, input token)

At a step 1120, the user writes high-level code to instruct compiler 822 to configure the topology of CGRP 106 to allow operation of the compute bound operations to be performed in a pipeline and storing data into memory, for example a pipeline of PCUs and memory. The sequence may include;
Load: (TP X, PP Y, Sharding Z, Operator Par 1)
Deq: (TP x, PP y, Sharding z, Operator par 1)
Lin: (TP x, PP y, Sharding z, operator par w).

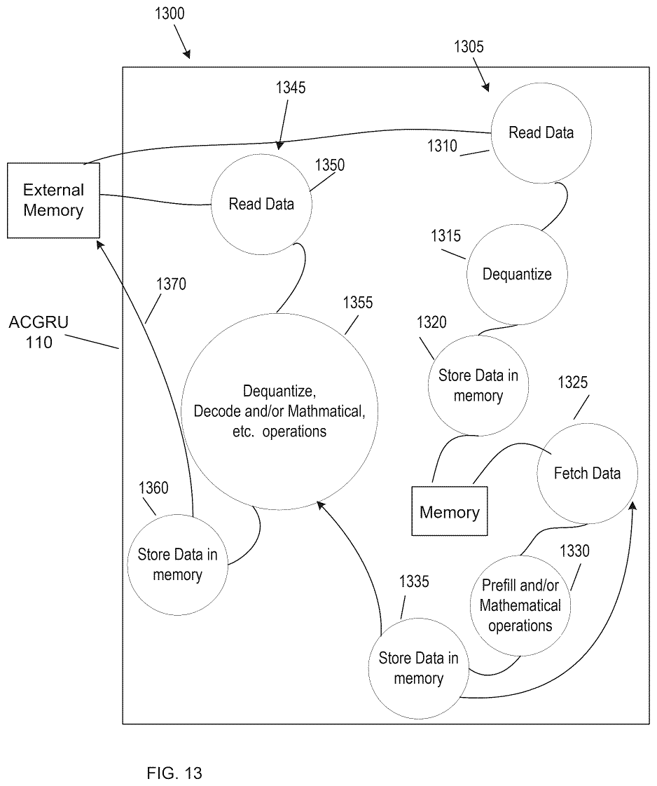

At a step 1125, compiler 822 compiles the source codes and generates the dataflow graph. Compiler 822 merges or stitches the user code from steps 1105-1120 with the graphs of the model which may include replacing some of the model graph elements with some of the user supplied code. The graphs when loaded onto CGRP 106 form a topology on CGRP 106 that organizes the CGRP 106 elements into the pipelines specified by the user code from steps 1105-1120. As will be seen in the description of FIG. 13, the dataflow graph includes a B/W graph 1345 for the B/W bound tasks and a separate compute graph 1305 for the compute bound tasks. The user created high-level software or code may be stored in portions of AF compiler 810 or in stack 812 (FIG. 8).

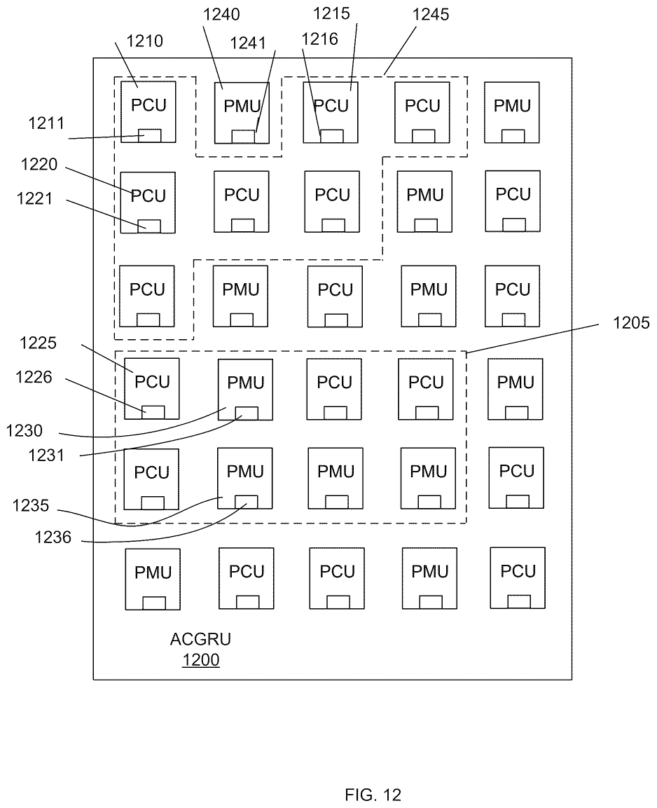

FIG. 12 is a block diagram illustrating an ACGRU 1200 that may be at least a portion of ACGRU 110 (FIG. 1). ACGRU 1200 includes a plurality of PCU(s), illustrated by PCUs 1210, 1215, 1220, and 1225, and a plurality of PMU(s), illustrated by PMUs 1230, 1235, and 1240 configured into an array as explained in the description of FIGS. 2-3. ACGRU 1200 may have an implementation that may be a portion of ACGRU 110. PCUs 1210, 1215, 1220, and 1225 include respective cfg stores 1211 and 1216, 1221, and 1226 which may be substantially the same as and operate substantially the same as cfg 450 and logic 460 described in the description of FIG. 4. PMUs 1230, 1235, and 1240 include respective cfg stores 1231, 1236, and 1241 which may be substantially the same as and operate substantially the same as cfg 618 described in the description of FIG. 6. Interconnection elements, such as the interconnects of ALN 113 and TLN 120 (FIG. 1) are not shown for clarity of the drawings. Compiler 822 translates and maps the dataflow graphs (for example logical nodes of the graphs) to a physical layout, or topology, of CGRP 106 as illustrated in general by FIG. 12.

The mapping for the B/W graph is placed and routed onto a plurality of PCUs illustrated in general by PCUs 1210, 1215, and 1220 (although other PCUs are included in the graph they are not numbered in the illustration). The mapping for the B/W graph configures the PCUs into a pipeline 1245, illustrated in a general manner by a dashed polygon. Configuring the plurality of PCUs into the pipeline allows the PCUs to perform the B/W graph operations using the pipelines within the PCUs and also using pipelined processing through multiple PCUs as explained in the description of FIG. 5. For example, compiler 822 may assign one or more PCUs to the pipeline for processing the B/W graph.

The mapping for the compute graph is placed and routed onto a plurality of PCUs and a plurality of PMUs, or other memory elements, as illustrated in general by PCU 1225 and PMUs 1230 and 1235 (although other PCUs and PMUs are included in the graph they are not numbered in the illustration). The mapping of the compute graph configures the PCUs and PMUs into a pipeline 1205, illustrated in a general manner by a dashed polygon. Configuring the plurality of PCUs and PMUs into the pipeline allows the PCUs to perform the compute graph operations using the pipelines within the PCUs or multiple PCUs, and to store the results in memory in the PMUs in-between some of the operations. For example, compiler 822 may assign one or more PCUs to the pipeline for processing the compute graph and one or more PMUs as stage buffers between the pipeline operations.

FIG. 13 illustrates in a general manner an example of a portion of an implementation of a method 1300 of operating ACGRU 110 (FIG. 1). Method 1300 illustrates some of the logic nodes of the method. Method 1300 may include creating a B/W graph 1345 and a compute graph 1305. Graphs 1305 and 1345 may be a portion of a graph that includes one or more of model(s) 840 (FIG. 8), for example a graph compiled by compiler 822 (FIG. 8). Compute graph 1305 may be used for the computed bound tasks and B/W graph 1345 may be used for B/W bound tasks, some examples of which are described hereinbefore such as in the description of model(s) 840 in the description of FIG. 8. B/W graph 1345 causes ACGRU 110 to perform differently than compute graph 1305. For example, B/W graph 1345 may include configuring a pipeline of PCUs, such as for example pipeline 1245 (FIG. 12), and performing the B/W bound tasks within pipeline 1245 without storing the data into a storage element that is external to pipeline 1245. For example, B/W graph 1345 may include operations to receive a first group of data and perform a first set of multiple operations on the first group of data without storing the data into a storage element in-between the multiple operations. B/W graph 1345 may also include that after completing the first set of multiple operations, other operations may be performed with pipeline 1245. After performing the multiple operations of graph 1345, the data may be stored into a memory that is within the ACGRUs, such as for example memory 116 (FIG. 1) or memory within PMUs of ACGRU 110 (FIG. 1). Compute graph 1305 may include configuring a pipeline of PCUs and memory elements, for example PMUs, as a pipeline 1205 (FIG. 12), and performing the compute bound operations within pipeline 1205 while storing the data into memory in-between the some of the compute bound operations. For example, compute graph 1305 may include operations to receive a second group of data and perform a second set of multiple operations on the second group of data including storing portions of the second group of data into a storage element or a memory that is within the ACGRUs, such as for example in the PMUs, in-between some of the second set of multiple operations. Compute graph 1305 may also include that after completing the second set of multiple operations, the second group of data may be stored into a memory that is within the ACGRUs, such as for example memory 116 (FIG. 1) or memory within PMUs of ACGRU 110 (FIG. 1). Other operations may be performed on the data within pipeline 1205 after the data is stored.

As explained hereinbefore, one or more of model(s) 840 may include tasks that are both compute bound and B/W bound, and/or one or more of model(s) 840 may include B/W bound tasks and another may include compute bound tasks. For example, the model(s) may include the prefill task that is compute bound and may include the decode task that is B/W bound. Graph 1345 illustrates in general some operations for the B/W bound decode tasks, and graph 1305 illustrates in general some operations for the compute bound prefill tasks.

Method 1300 may include that compute graph 1305 may, as illustrated at a node 1310, be configured to cause ACGRU 110 to read data from a user, for example a user that is external to ACGRU 110, or for example read the data from memory such as memory 128 (FIG. 1). In an implementation, the input data from the user may have been stored in memory 128 by one of model(s) 840 after the model has received the data from the external user. Graph 1305 includes dequantizing the model data, such as for example model parameters, in a PCU of ACGRU 110, such as for example one or more PCUs of pipeline 1205 (FIG. 12), as illustrated by node 1315. As illustrated by node 1320, the dequantized model data or dequant data may then be stored into a storage element, for example a memory, within ACGRU 110, such as MS 613 (FIG. 6) of a PMU or other memory of ACGRU 110 such as memory 116 or 281. Subsequently the dequant model data may be read from the memory, as illustrated by a node 1325, and at a node 1330 other compute bound operations may be performed within the pipeline using the data. For example at node 1330, the dequant model data may be used for generating one or more draft data tokens for the prefill operation. An implementation may include that the dequant model data may be used to process multiple draft data tokens in parallel in the pipeline, such as for example pipeline 1205. The prefill operation may include invoking execution of one or more of model(s) 840 to form the prefill analysis using the dequant data. As illustrated by node 1335, the data, such as for example draft data tokens, resulting from the other compute bound operations, such for example prefill, may be stored into memory with pipeline 1205 (FIG. 12) or other memory or other storage elements of ACGRU 110. Execution of graph 1305 does not store dequantized model data or draft data tokens in storage elements that are external to ACGRU 110 which reduces processing time because external memory operations are not needed. The data resulting from the operations of graph 1305, such as for example prefill draft data tokens, may be used subsequently by B/W graph 1345. Nodes 1315, 1320, 1325, and 1330 illustrate, in a general manner, that compute graph 1305 reads the model data, dequantizes the model data, stores the dequantized model data or dequant data into memory of ACGRU 110, reads the dequant data from memory, and performs additional operations, such as prefill, on the input data by using the dequant data, then stores some of the data, such as for example draft data tokens, into memory within ACGRU 110 so that it can be used by other graphs, such as graphs of one or more of model(s) 840. The data is stored into a memory that is within ACGRU 110 such as memory 116 or 281 or 613. Separating the dequantization operations from the other operations, such as the prefill operations, and storing the dequantized model data in memory in-between the two operations allows more of the computing resources, such as for example PCU's of CGRP 106, to be used for other operations thereby improving the overall execution speed of the system. Thus, compute graph 1305 improves the overall speed of performing the task(s) of system 100 and alternately model(s) 840. Additionally, keeping the dequantized model data and results of the other operations, for example the prefill operations, within ACGRU 110 also assists in improving processing speed, for example the external memory does not have to be accessed. Even though the processing time for the compute graph may be slower than it is for the B/W graph (as will be seen further hereinafter), the overall system processing speed is improved because the compute graph allows resources to be used by other tasks.

B/W graph 1345 of method 1300 may, as illustrated by a node 1350, be configured to cause ACGRU 110 to read model data from memory that is external to ACGRU 110, such as memory 128. For example, the data may be at least a portion of model parameters and/or a part of an initial k/v cache that are stored external to ACGRU 110. The model data is brough into a pipeline having one or more PCUs such as the PCUs in pipeline 1245 (FIG. 12). A node 1355 illustrates that the method may dequantize the model data in the pipeline and then perform operations using the model data while still in the pipeline. In an implementation, some of the B/W bound operations include dequantizing the model data to form dequant data, then using the dequant data for performing the decode operation while still in the pipeline, and without storing the data, including the dequant data, into a storage element that is external to the pipeline, including not storing in memory within ACGRU 110 or memory that is external to ACGRU 110. The decode operation may include invoking execution of one or more of model(s) 840 to perform the decode analysis by using the dequantized data. In an implementation, the decode operation at node 1355 may include reading the prefill data from node 1335 to perform the decode operation on the prefill data, such as for example analyzing the draft data tokens, while using data from the k/v cache to assist in the decode operation. Other operations, such as matrix comparisons or matrix mathematical operations may also be performed as a part of the operations at node 1355. An implementation may include that the decode operations may be processed through the same pipeline elements that perform the dequantization operations thereby reducing the processing time. Thereafter, the method may store at least a portion of the decode data, such as for example the accepted draft tokens, into memory of ACGRU 110 as illustrated by a node 1360. Additionally, the method may include quantizing any modified k/v cache data and storing the quantized modified cache data back into memory that may be external to ACGRU 110, such as for example illustrated by an arrow 1370. Performing the dequantization operation and the decode operations, and any other mathematical operation, on the dequantized model data without an intermediate storage operation results in a faster dequantization speed and faster processing of the B/W graph operations. Additionally, keeping the dequantized model data and results of the decode operations within ACGRU 110 also assists in improving processing speed, for example the external memory does not have to be accessed.

It has been found that the overall system processing speed for a method using the two different graphs for the two different cases of B/W bound operations and compute bound operations may be up to approximately twice (2) as fast as a method that uses one graph for both cases. Thus, there is an advantage in having a separate B/W graph and a separate compute graph that use two different flows for the dequantization and other operations.

Although the method was explained for the operations of one or more of model(s) 840, using separate graphs for B/W bound and compute bound operations also applies to graphs that include two or more of model(s) 840 wherein one has a B/W bound operation and the other has a compute bound operation.

### Particular Implementations

Those skilled in the art will appreciate that an implementation of a data processing system, such as for example system 100 or system 200, may include one or more coarse grained reconfigurable processors, such as for example processor 106 or ACGRUs 110, 210 or 212, having an array of coarse grained reconfigurable configurable units, such as for example ACGRUs 110, 210 or 212, including a plurality of pattern compute units, such as for example PCUs 301, 400 or 1210 and 1215, that is configured to execute a dataflow graph, such as for example one or more of graphs 1350 and 1360, that, when executed on the one or more coarse grained reconfigurable processors implements actions comprising:
configure a first section of the plurality of PCUs, such as for example PCUs 1225 and a first section of a plurality of pattern memory units, such as for example PMUs 1230 and 1235, into a first meta-pipeline, such as for example pipeline 1205, of PCUs and PMUs wherein the first meta-pipeline is devoid of an FP8 arithmetic unit;
configure a second section of the plurality of PCUs, such as for example PCUs 1210, 1215, and 1220, into a second meta-pipeline, such as for example pipeline 1245, of PCUs wherein the second meta-pipeline of PCUs is devoid of an FP8 arithmetic unit;
read a first group of data, such as for example user input data, from a first memory, such as for example memory 128, that is external to the array of coarse grained reconfigurable configurable units;
transmit the first group of data into the first meta-pipeline;
perform calculations on the first group of data within the first meta-pipeline including: dequantizing the first group of data from FP8 format to one of a 32-bit floating point format, or a 16-bit brain floating point format to form a first dequant data;
   storing the first dequant data into one or more PMUs within the second meta-pipeline;
   reading the first dequant data from the one or more PMUs; and
   performing additional mathematical functions on the first dequant data to form prefill data;
store the prefill data into a second memory that is within the ACGRUs;
read a second group of data, such as for example model parameters and/or k/v cache data, from the first memory;
transmit the second group of data into the second meta-pipeline;
perform calculations on the second group of data within the first meta-pipeline without storing the second group of data into a memory that is within the ACGRUs or external to the ACGRUs, wherein perform calculations includes:
   dequantizing at least a portion of the second group of data, such as for example model parameters, from FP8 format to one of a 32-bit floating point format or a 16-bit brain floating point format to form a second dequant data;
   perform additional mathematical functions, such as for example decode/verify prefill tokens, on the second dequant data to form inference data; and
store the inference data into a third memory that is within the ACGRUs.

An implementation of system of claim 1 may include one or more single-instruction multiple-data, such as for example SIMD 510 or 520, arithmetic logic units.

The system may also include an implementation wherein reading the first group of data includes reading data supplied by a user of the data processing system.

In an implementation, the system may also include converting the first dequant data into first tokens that represent the first dequant data and also creating prefill tokens that speculate additional data that might follow the first dequant data.

Another implementation of the system may also include read the second group of data from a k/v cache.

An implementation of the system may include using the second dequant data to verify if the inference data has a high probability of being accepted by a user of the data processing system.

Another implementation may include executing the dataflow graph to configure the first section of the plurality of PCUs and the first section of the plurality of pattern memory units into the first meta-pipeline.

In an implementation, the system may further include configuring a compiler to form the dataflow graph to configure the first meta-pipeline and the second meta-pipeline.

The system of claim 1 may have an implementation that may further include a non-transitory computer readable storage medium, such as for example CRMs 131 or 752, for storing a computer program instructions for the system.

Another implementation may include dequantizing the first group of data from FP8 format to a 16-bit floating point format to form the first dequant data.

The system may also include that the second meta-pipeline is devoid of a PMU.

One of ordinary skill in the art will appreciate an example of an implementation of a coarse grained reconfigurable processor including an array of coarse grained reconfigurable units, such as for example ACGRUs 110, may have a plurality of pattern compute units, such as for example PCUs 301, 400 or 1210 and 1215 1225, and a plurality of pattern memory units, such as for example PMUs 1230 and 1235, comprising:
a first section of the plurality of PCUs and a first section of the plurality of PMUs configured into a first meta-pipeline, such as for example 1205, having one or more PCUs coupled with a PMU;
a second section of the plurality of PCUs configured into a second meta-pipeline, such as for example pipeline 1245, of PCUs;
the first meta-pipeline configured to receive a first group of data, such as for example user input data, from external to the array of coarse grained reconfigurable configurable units, such as for example ACGRUs 110 and 200, to perform a first set of multiple operations, such as for example prefill/speculate, on the first group of data including storing the first group of data into a first memory within the ACGRU in-between some of the first set of multiple operations;
the first meta-pipeline configured to store the first group of data into one of the first memory or a second memory within the ACGRUs after completing the first set of multiple operations;
the second meta-pipeline configured to receive a second group of data, such as for example model parameters and/or k/v cache, from external to the array of coarse grained reconfigurable configurable units and perform a second set of multiple operations, such as for example decode/verify operations, on the second group of data without storing the second group of data into a storage element that is external to the second meta-pipeline; and
the second meta-pipeline configured to store the second group of data into a storage element that is external to the second meta-pipeline after completing the second set of multiple operations.

The processor may have an implementation that may include receiving input data from a user external to the ACGRUs.

An implementation of the processor may also include dequantizing the first set of data to form a first dequant data, storing some of the first dequant data into the first memory, and subsequently speculating additional data to add to the first dequant data.

In an implementation, the processor may include receiving k/v cache data.

The processor of claim 15 may also have an implementation that may include dequantizing the k/v cache data to form a second dequant data and using the second dequant data to form a probability that the additional data is correct, wherein forming the second dequant data and forming the probability are performed within the second meta-pipeline without storing the second group of data or the second dequant data into the storage element that is external to the second meta-pipeline.

Another implementation of the processor may be devoid of a PMU or storage elements external to the second section of PCUs.

Those skilled in the art will appreciate that in an implementation of computer implemented method of processing types of data for a coarse grained reconfigurable processor, such as for example CGRP 106, that includes an array of coarse grained reconfigurable units, such as for example ACGRUs 110, having a plurality of pattern compute units, such as for example PCUs 301, 400, 1210,1215, 1225, and a plurality of pattern memory units, such as for example PMUs 1230 and 1235, the method may comprise:
receiving from a compiler, such as for example compiler 822, a dataflow graph having a B/W bound operations, such as for example decode/verify tasks, and a compute bound operation(s), such as for examples peculate/prefill;
configuring a first section of the plurality of PCUs, via the dataflow graph, such as for example B/W bound, into a first meta-pipeline, such as for example pipeline 1245;
configuring a second section of the plurality of PCUs and a first section of the plurality of PMUs, via the dataflow graph, such as for example compute bound, into a second meta-pipeline, such as for example pipeline 1205;
configuring the first meta-pipeline, via the dataflow graph, to perform the B/W bound operations including receive a first group of data, such as for example model parameters, and perform a first set of multiple operations on the first group of data without storing the first group of data into a storage element that is external to the first meta-pipeline, and after completing the first set of multiple operations store the first group of data into a first memory that is within the ACGRUs; and
configuring the second meta-pipeline, via the dataflow graph to perform the compute bound operations including receive a second group of data, such as for example user input data, and perform a second set of multiple operations, such as for example dequant and prefill, on the second group of data including store portions of the second group of data into a second memory that is within the ACGRUs in-between some of the second set of multiple operations, and after completing the second set of multiple operations store the second group of data into one of the first memory or the second memory or another memory that is within the ACGRUs.

The method may have an implementation that may include receiving a first dataflow graph having the B/W bound operations and that is configured to form the first meta-pipeline.

An implementation of the method may include receiving the second dataflow graph having the compute bound operations and that is configured to form the second meta-pipeline.

Those skilled in the will appreciate that and implementation of a system including an array of coarse grained reconfigurable units coupled to a memory, the memory loaded with program instructions to optimize processing speed within the array of course grained reconfigurable units, wherein the program instructions, when executed on the array of coarse grained reconfigurable units, implements actions comprising:
configure a first section of a plurality of pattern compute units, such as for example PCUs 1225, of the array of coarse grain reconfigurable units and a first section of a plurality of pattern memory units, such as for example PMUs 1230 and 1235, of the array of course grained reconfigurable units into a first pipeline, such as for example pipeline 1205;
configure a second section of a plurality of pattern compute units, such as for example PCU 1210 and 1215, of the array of course grain reconfigurable units into a second pipeline, such as for example pipeline 1245;
configure the first pipeline to read a first input data received from external to the array of course grained reconfigurable units, dequantize at least a portion of the first input data into a first dequant data, store the first dequant data into a memory that is within the array of coarse grained reconfigurable units, and use the first dequant data to speculate a first speculation data that may follow the first input data; and
configure the second pipeline to read a second input data received from external to the array of course grained reconfigurable units, dequantize at least a portion of the first input data into a first dequant data and use the second dequant data to analyze the second data, store the dequant data into a memory that is within the array of coarse grained reconfigurable units, and use the first dequant data to analyze the first speculation second data without storing the second dequant data into any memory that is external to the first pipeline.

One of ordinary skill in the art will appreciate that and implementation of a system including an array of coarse grained reconfigurable units coupled to a memory, the memory loaded with program instructions including program instructions to optimize processing speed within the array of course grained reconfigurable units, wherein the program instructions, when executed by the system, implements actions comprising:
determine that a first set of program instructions include bandwidth bound tasks;
determined that a second set of program instructions include compute bound tasks;
map a first set of pattern compute units of the array of coarse grain reconfigurable units into a first pipeline, such as for example pipeline 1245;
map a second set of PMUs of the array of coarse grain reconfigurable units and a first a set of pattern memory units of the array of coarse grain reconfigurable units into a second pipeline, such as for example pipeline 1205;
configure the first pipeline to execute the first set of program instructions within the first pipeline without storing resulting data into a memory that is external to the first pipeline; and
configure the second pipeline to execute the second set of program instructions within the second pipeline including storing intermediate resulting data into a memory that is within to the array of coarse grained reconfigurable units.

In view of all of the above, it is evident that a novel method and system are disclosed. Included, among other features, is a method that uses two different graphs for the two different cases of processing B/W bound operations and processing compute bound operations. Using the two different graphs reduces the overall system processing time, which improves system throughput.

While the subject matter of the descriptions are described with specific implementations and example implementations, the foregoing drawings and descriptions thereof depict only typical and non-limiting examples of implementations of the subject matter and are not therefore to be considered to be limiting of its scope, it is evident that many alternatives and variations will be apparent to those skilled in the art. As will be appreciated by those skilled in the art, the example form of system 100, array 200, PCU 400, and graphs 1305/1345 are used as a vehicle to explain the operation method of controlling the system to perform the B/W bound and compute bound tasks. The systems may be configured with various other implementations in addition to the illustrated implementations as long as they use two different procedures to process two different tasks such as the B/W bound and compute bound tasks.

As can also be seen from all the foregoing, any combination of one or more computer-readable storage medium(s) may be utilized. A computer-readable storage medium may be embodied as, for example, an electronic, magnetic, optical, electromagnetic, infrared, or semiconductor system, apparatus, or device, or other like storage devices known to those of ordinary skill in the art, or any suitable combination of computer-readable storage mediums described herein. In the context of this document, a computer-readable storage medium may be any tangible medium that can contain, or store, a program and/or data for use by or in connection with an instruction execution system, apparatus, or device. Even if the data in the computer-readable storage medium requires action to maintain the storage of data, such as in a traditional semiconductor-based dynamic random-access memory, the data storage in a computer-readable storage medium can be considered to be non-transitory.

Additionally, the computer program code, or resulting graphs if executed by a processor, causes physical changes in the electronic devices of the processor which change the physical flow of electrons through the devices. This alters the connections between devices which changes the functionality of the circuit. For example, if two transistors in a processor are wired to perform a multiplexing operation under control of the computer program code, if a first computer instruction is executed, electrons from a first source flow through the first transistor to a destination, but if a different computer instruction is executed, electrons from the first source are blocked from reaching the destination, but electrons from a second source are allowed to flow through the second transistor to the destination. So, a processor programmed to perform a task is transformed from what the processor was before being programmed to perform that task, much like a physical plumbing system with different valves can be controlled to change the physical flow of a fluid.

As the claims hereinafter reflect, inventive aspects may lie in less than all features of a single foregoing disclosed implementation(s). Thus, the hereinafter expressed claims are hereby expressly incorporated into this Detailed Description, with each claim standing on its own as a separate implementation of an implementation. Furthermore, while some implementations described herein include some but not other features included in other implementations, combinations of features of different implementations are meant to be within the scope of the claims and implementations, and form different implementations, as would be understood by those skilled in the art.

1. A data processing system including one or more coarse grained reconfigurable processors having an array of coarse grained reconfigurable configurable units (ACGRUs) including a plurality of pattern compute units (PCUs) that is configured to execute a dataflow graph that, when executed on the one or more coarse grained reconfigurable processors implements actions comprising:
configure a first section of the plurality of PCUs and a first section of a plurality of pattern memory units (PMUs) into a first meta-pipeline of PCUs and PMUs wherein the first meta-pipeline is devoid of an FP8 arithmetic unit;
configure a second section of the plurality of PCUs into a second meta-pipeline of PCUs wherein the second meta-pipeline of PCUs is devoid of an FP8 arithmetic unit;
read a first group of data from a first memory that is external to the array of coarse grained reconfigurable configurable units (ACGRUs);
transmit the first group of data into the first meta-pipeline;
perform calculations on the first group of data within the first meta-pipeline including:
dequantizing the first group of data from FP8 format to one of a 32-bit floating point format (FP32) or a 16-bit brain floating point (BF16) format or a 16-bit floating point (FP16) format to form a first dequant data;
storing the first dequant data into one or more PMUs within the second meta-pipeline;
reading the first dequant data from the one or more PMUs; and
performing additional mathematical functions on the first dequant data to form prefill data;
store the prefill data into a second memory that is within the ACGRUs;
read a second group of data from the first memory;
transmit the second group of data into the second meta-pipeline;
perform calculations on the second group of data within the first meta-pipeline without storing the second group of data into a memory that is within the ACGRUs or external to the ACGRUs, wherein perform calculations includes:
dequantizing the second group of data from FP8 format to one of a 32-bit floating point format (FP32) or a 16-bit brain floating point (BF16) format or a 16-bit floating point (FP16) format to form a second dequant data;
perform additional mathematical functions on the second dequant data to form inference data; and
store the inference data into a third memory that is within the ACGRUs.

2. The data processing system of claim 1 wherein at least a portion of the first section of the plurality of PCUs and at least a portion of the second section of the plurality of PCUs include one or more single-instruction multiple-data (SIMD) arithmetic logic units.

3. The data processing system of claim 1 wherein read a first group of data includes reading data supplied by a user of the data processing system.

4. The data processing system of claim 1 wherein performing additional mathematical functions on the first dequant data includes converting the first dequant data into first tokens that represent the first dequant data and includes creating prefill tokens that speculate additional data that might follow the first dequant data.

5. The data processing system of claim 1 wherein read the second group of data from the first memory includes read the second group of data from a k/v cache.

6. The data processing system of claim 1 wherein perform additional mathematical functions on the second dequant data includes using the second dequant data to verify if the inference data has a high probability of being accepted by a user of the data processing system.

7. The data processing system of claim 1 wherein configure the first section of the plurality of PCUs and the first section of the plurality of pattern memory units (PMUs) into the first meta-pipeline includes executing the dataflow graph to configure the first section of the plurality of PCUs and the first section of the plurality of pattern memory units (PMUs) into the first meta-pipeline.

8. The data processing system of claim 7 further including configuring a compiler to form the dataflow graph to configure the first meta-pipeline and the second meta-pipeline.

9. The data processing system of claim 1 further including a non-transitory computer readable storage medium (CRM) for storing a computer program instructions for the system.

10. The data processing system of claim 1 wherein dequantizing the first group of data from FP8 format includes dequantizing the first group of data from FP8 format to a higher precision format to form the first dequant data.

11. The data processing system of claim 1 wherein the second meta-pipeline is devoid of a PMU.

12. A coarse grained reconfigurable processor including an array of coarse grained reconfigurable units (ACGRUs) having a plurality of pattern compute units (PCUs) and a plurality of pattern memory units (PMUs) comprising:
a first section of the plurality of PCUs and a first section of the plurality of PMUs configured into a first meta-pipeline having one or more PCUs coupled with a PMU;
a second section of the plurality of PCUs configured into a second meta-pipeline of PCUs;
the first meta-pipeline configured to receive a first group of data from external to the array of coarse grained reconfigurable configurable units (ACGRUs) and to perform a first set of multiple operations on the first group of data including storing the first group of data into a first memory within the ACGRUs in-between some of the first set of multiple operations;
the first meta-pipeline configured to store the first group of data into one of the first memory or a second memory within the ACGRUs after completing the first set of multiple operations;
the second meta-pipeline configured to receive a second group of data from external to the array of coarse grained reconfigurable configurable units (ACGRUs) and perform a second set of multiple operations on the second group of data without storing the second group of data into a storage element that is external to the second meta-pipeline; and
the second meta-pipeline configured to store the second group of data into a storage element that is external to the second meta-pipeline after completing the second set of multiple operations.

13. The coarse grained reconfigurable processor of claim 12 wherein receive the first group of data from external to the array of coarse grained reconfigurable configurable units includes receiving input data from a user external to the ACGRUs.

14. The coarse grained reconfigurable processor of claim 13 wherein perform the first set of multiple operations on the first group of data includes dequantizing the first set of data to form a first dequant data, storing some of the first dequant data into the first memory, and subsequently speculating additional data to add to the first dequant data.

15. The coarse grained reconfigurable processor of claim 14 wherein receive the second group of data from external to the ACGRUs includes receiving k/v cache data.

16. The coarse grained reconfigurable processor of claim 15 wherein perform the second set of multiple operations includes dequantizing the k/v cache data to form a second dequant data and using the second dequant data to form a probability that the additional data is correct, wherein forming the second dequant data and forming the probability are performed within the second meta-pipeline without storing the second group of data or the second dequant data into the storage element that is external to the second meta-pipeline.

17. The coarse grained reconfigurable processor of claim 12 wherein the second meta-pipeline is devoid of a PMU or storage elements external to the second section of PCUs.

18. A computer implemented method of processing types of data for a coarse grained reconfigurable processor (CGRP) including an array of coarse grained reconfigurable units (ACGRUs) having a plurality of pattern compute units (PCUs) and a plurality of pattern memory units (PMUs), the method comprising:
receiving from a compiler a dataflow graph having a B/W bound operations and a compute bound operations;
configuring a first section of the plurality of PCUs, via the dataflow graph, into a first meta-pipeline;
configuring a second section of the plurality of PCUs and a first section of the plurality of PMUs, via the dataflow graph, into a second meta-pipeline;
configuring the first meta-pipeline, via the dataflow graph, to perform the B/W bound operations including receive a first group of data and perform a first set of multiple operations on the first group of data without storing the first group of data into a storage element that is external to the first meta-pipeline, and after completing the first set of multiple operations store the first group of data into a first memory that is within the ACGRUs; and
configuring the second meta-pipeline, via the dataflow graph, to perform the compute bound operations including receive a second group of data and perform a second set of multiple operations on the second group of data including store portions of the second group of data into a second memory that is within the ACGRUs in-between some of the second set of multiple operations, and after completing the second set of multiple operations store the second group of data into one of the first memory or the second memory or another memory that is within the ACGRUs.

19. The method of claim 18 wherein receiving from the compiler the dataflow graph includes receiving a first dataflow graph having the B/W bound operations and that is configured to form the first meta-pipeline.

20. The method of claim 19 wherein receiving from the compiler the dataflow graph includes receiving second dataflow graph having the compute bound operations and that is configured to form the second meta-pipeline.
